(19) United States
(12) Patent Application Publication
(10) Pub. No.: US 2019/0258807 A1
(43) Pub. Date: Aug. 22, 2019

(54) AUTOMATED ADJUSTING OF DEVICES

(71) Applicant: MCS2, LLC, Dublin, OH (US)

(72) Inventors: John P DiMaggio, Powell, OH (US); Edward N Stone, Dublin, OH (US)

(21) Appl. No.: 16/373,630

(22) Filed: Apr. 3, 2019

Related U.S. Application Data
(63) Continuation-in-part of application No. 15/715,588, filed on Sep. 26, 2017.

(51) Int. Cl. G06F 21/57; G06F 21/55; H04L 29/08; G06F 21/62; G06N 20/00; G06K 9/62

(52) U.S. Cl. CPC G06F 21/577; G06F 21/552; H04L 67/125; G06F 21/554; G06N 20/00; G06K 9/6227; G06F 21/6245

(57) ABSTRACT

The subject disclosure relates to systems, methods, and devices that automatically adjust an attribute or configuration (e.g., physical configuration) of a device based on a security vulnerability score. In an aspect, the disclosure includes sourcing module, determination module, scoring module, analysis module, and an adjustment module. In an aspect, the analysis module can be configured to compare the security vulnerability score to a lower security vulnerability score corresponding to another device that is different from the device, wherein the lower security vulnerability score represents a more secure device than the security vulnerability score. Furthermore, the adjustment module can be configured to automatically adjust the device attributes or the device components to match at least some another device attributes or another device components to decrease the security vulnerability score.

### PRIORITY

This application claims priority to U.S. Non-Provisional patent application Ser. No. 15/715,588 filed on Sep. 26, 2017 and entitled “DETERMINING RISK LEVEL AND MATURITY OF COMPLIANCE ACTIVITIES”, which claims priority to U.S. Non-Provisional patent application Ser. No. 15/207,469 filed on Jul. 11, 2016 and entitled “METHODS AND SYSTEMS FOR STORING AND VISUALIZING MANAGED COMPLIANCE PLANS”, which claims priority of U.S. Non-Provisional patent application Ser. Nos. 15/053,991 and 15/330,967 both filed on Feb. 25, 2016 and entitled “METHODS AND SYSTEMS FOR MANAGING COMPLIANCE PLANS”, which claim priority to U.S. Provisional Patent Application No. 62/120,972 filed on Feb. 26, 2015 and entitled “METHOD AND SYSTEM FOR MANAGING COMPLIANCE PLANS”. The entirety of the aforementioned applications are incorporated by reference herein.

### BACKGROUND

Many organizations utilize large quantities of healthcare information including protected health information which are subject to privacy rules and regulations. As such, the safeguarding of such information is of utmost importance to such organizations. Unfortunately, there are constant and continuous threats to the safety of such information on a daily basis. However, current protection mechanisms for such information are antiquated and ineffective at mitigating threats to privacy breaches of such information or to adequately protecting such information from theft. Accordingly, new technologies and solutions are needed to provide the necessary security for such information.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that facilitate a determination of a maturity level representing a state of compliance and a risk score representing a vulnerability of a set of protected data in accordance with one or more embodiments described herein.

According to an embodiment, a system is provided. The system comprises a processor that executes computer executable modules stored in memory. The computer executable modules comprise a sourcing module configured to receive device data corresponding to device components and device attributes of a device based at least on a device scanning system. Furthermore, the computer executable modules comprise a determination module configured to determine a baseline value corresponding to a security status of the device based on device data. In another aspect, the computer executable modules comprise a scoring module configured to generate a security vulnerability score of the device based on a comparison of the baseline value to a threshold value representing security vulnerabilities of the device components and the device attributes.

In yet another aspect, the computer executable modules comprise an analysis module configured to compare the security vulnerability score to a lower security vulnerability score corresponding to another device that is different from the device, wherein the lower security vulnerability score represents a more secure device than the security vulnerability score. Also, the computer executable modules can comprise an adjustment module configured to automatically adjust the device attributes or the device components to match at least some another device attributes or another device components to decrease the security vulnerability score.

According to another embodiment, a computer-implemented method is provided. The computer-implemented method can comprise transmitting, by a device, device data corresponding to device components and device attributes of the device based on a request of a device scanning system. The computer-implemented method can also comprise automatically adjusting, by the device, at least one of a device orientation, a device screen display setting, a device physical position or location, or a device camera span of view based on control data or configuration data received from an automated control system. According to yet another embodiment, the computer-implemented method can comprise automatically adjusting, by the device, the device attributes or a configuration of the device components based on a security vulnerability score being less than a threshold security vulnerability score.

### BRIEF DESCRIPTION OF THE DRAWINGS

FIG. 1 illustrates a block diagram of an example, non-limiting representative environment 100, in which automated adjustment of device attributes, components, or configurations can occur based on vulnerability scores in accordance with one or more non-limiting embodiments described herein.

FIG. 2 illustrates a block diagram of an example, non-limiting representative environment 200, in which vulnerability insights can be generated from a machine learning algorithm based on the extraction of machine learning parameters from another machine learning algorithm in accordance with one or more embodiments described herein.

FIG. 3 illustrates a block diagram of an example, non-limiting representative environment 300, in which relationship models are generated between vulnerability insights and automated adjustments to device attributes or device components in accordance with one or more embodiments described herein.

FIG. 4 illustrates a block diagram of an example, non-limiting representative environment 400, in which a device attribute or a configuration of a device component is automatically adjusted based on the predicting of the adjusted security vulnerability score in accordance with one or more embodiments described herein.

FIG. 5 illustrates a block diagram of an example, non-limiting representative environment 500, in which a device such as a display device can be automatically adjusted based on an occurrence of a predetermined vulnerability pattern in accordance with one or more embodiments described herein.

FIG. 6 illustrates a block diagram of an example, non-limiting representative environment 600, in which changes in security vulnerability scores and adjustment data corresponding to automatic adjustments to device attributes or device components are stored at one or more nodes of a chain of nodes within a blockchain data store in accordance with one or more embodiments described herein.

FIG. 7 illustrates a block diagram of an example, non-limiting representative environment 700, in which images are stitched based on a stitching algorithm, captured by the camera recording technology corresponding to at least two of the devices to generate a field of view that provides context to a location to the at least two of the one or more devices in accordance with one or more embodiments described herein.

FIG. 8 illustrates a block diagram of an example, non-limiting representative environment 800, in which hyperparameters and learnings can be extracted from a machine learning algorithm applied to vulnerability data corresponding to a first device and integrated into another machine learning algorithm for application on vulnerability data corresponding to a different device in accordance with one or more embodiments described herein.

FIG. 9 illustrates a flow diagram of an example, non-limiting representative computer-implemented method 900 that can facilitate an automated adjustment of device attributes, components, or configurations based on vulnerability scores in accordance with one or more non-limiting embodiments described herein.

FIG. 10 illustrates a flow diagram of an example, non-limiting representative computer-implemented method 1000 that can facilitate an automated adjustment of device attributes, components, or configurations based on vulnerability scores in accordance with one or more non-limiting embodiments described herein.

FIG. 11 illustrates a block diagram of an example, non-limiting operating environment 1100 in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, this disclosure includes systems and methods for enhancing security of devices in part by implementing and/or triggering automated physical device adjustments. In an aspect, systems disclosed herein can detect (e.g., using a device sensor) an occurrence of increased vulnerabilities to systems and devices that utilize private information. Upon the detection of such increased vulnerability, a vulnerability score can be generated and upon such vulnerability score being greater than a threshold score, an automated adjustment to a device occurs until the vulnerability score is reduced to a target vulnerability level. Thus, the methods, systems and devices disclosed herein perform operations that reduce vulnerabilities to systems and devices (e.g., some devices that utilize protected health information) that utilize private information or are governed by security regulations and compliance regimes.

In an aspect, several devices of various organizations (e.g., hospitals, physicians, pharmacies, users, long term care organizations, laboratories, etc.) access and utilize healthcare information including protected health information (PHI). Such organizations are charged with protecting and safeguarding medical patient information that is accessed, stored and/or utilized. As such, a range of devices are often utilized to access, store, utilize or contribute to the access, storage, or utilization of healthcare information. Furthermore, those devices are expected to provide security and safeguards such that information executed, stored, accessed, or otherwise used by such devices are protected. This disclosure includes systems, devices, and methods for manipulating, adjusting, reconfiguring, and/or physically changing or adjusting such devices to improve security and/or decrease security vulnerabilities corresponding to such devices.

Accordingly, the disclosed systems and devices provide for automated adjustments to device mechanisms to procure physical and non-physical security enhancements based on detected vulnerabilities. Furthermore, systems, methods, and devices are disclosed that can trigger the adjustment of such devices based on detection or determinations of the occurrence of threshold security vulnerabilities associated with such devices. In various non-limiting embodiments, disclosed herein, automated adjustments to devices can be employed based on determinations of one or more baseline security status of devices, detection of occurrences of vulnerability events beyond tolerable levels via score generation, analysis of vulnerability scores across a series of devices (some similarly situated), and other mechanisms.

In other non-limiting embodiments, the automated adjustments to device attributes, device physical positioning (e.g., movement of orientation, location, etc.), device configurations, location of device components, resource allocation amongst devices, device visibility or viewability and other such adjustments can be based on other executed operations of systems disclosed herein. For instance, machine learning parameters that define the efficacy of a model to procure insights (e.g., of the presence of vulnerabilities corresponding to devices) can be extracted and applied to machine learning models applied to devices with greater vulnerability scores. Furthermore, automated device adjustments that procured vulnerability lowering outcomes of other devices can be performed on such increasingly vulnerable devices based on the extraction and re-application of machine learning parameters to procure such insights. As such, automated adjustments can be implemented in connection with various systems and devices disclosed herein.

As another example, predictive analytics and machine learning algorithms can be employed to curate, extract, transform and/or process device data to generate insights about the vulnerability and/or security of such devices and accordingly implement automated adjustments to such devices based on the procurement of such vulnerabilities. Furthermore, disclosed are various implementations of platform technologies that provide automated device adjustments and vulnerability determinations to several (e.g., millions) devices simultaneously based on the generation of insights, some common to groups of devices, on a continuous basis. Consider now an example environment in which various aspects as described herein can be employed.

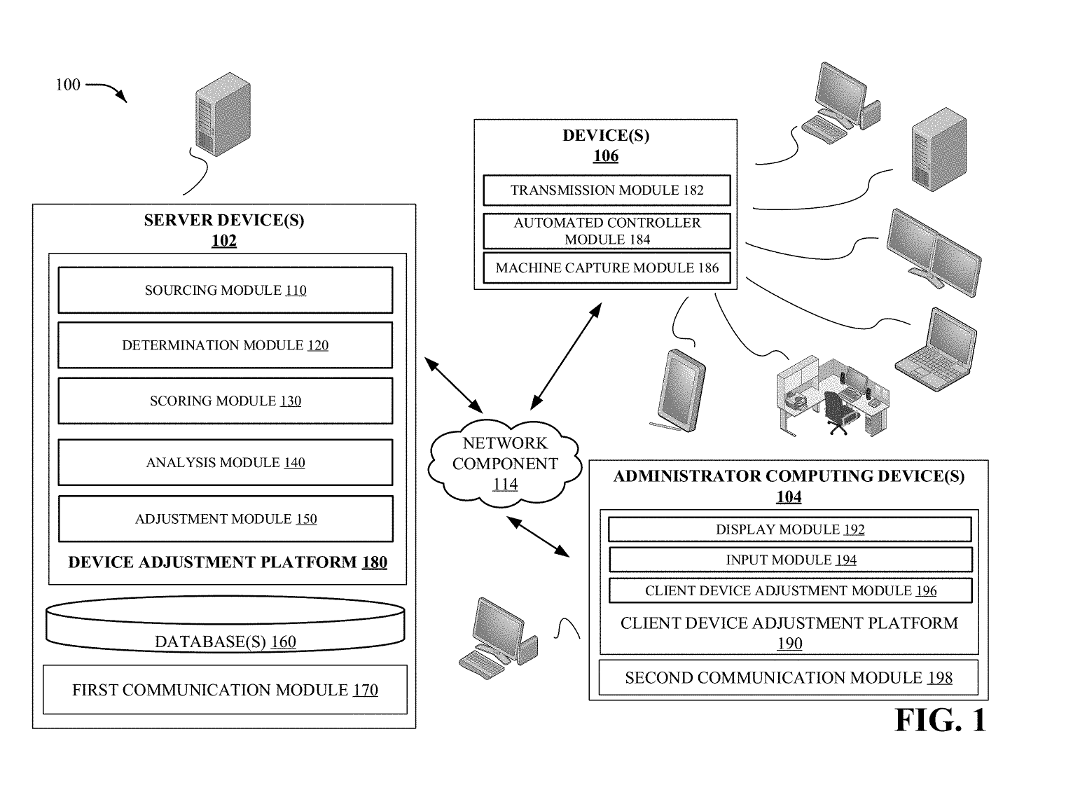

FIG. 1 illustrates a block diagram of an example, non-limiting representative environment 100 in which automated adjustment of device attributes, components, or configurations based on vulnerability scores in accordance with one or more non-limiting embodiments described herein.

In an aspect, environment 100 can include an example system that can be used to perform automated adjustments of device(s) 106 in accordance with one or more implementation. Included in environment 100 are server(s) 102, administrator computing device(s) 104, and device(s) 106 that can coalesce to provide automated adjustments of device(s) based on security score determinations. In an aspect, administrator computing device(s) 104 can be any of a range of computing device such as a desktop computing device, personal digital assistant, smart phone, tablet, laptop, smart watch, set top box, and other such computing devices. The term “adjustment of device(s)” or “device adjustment(s)” can denote an automated action that is used to adjust device attributes, adjust device components, adjust device configurations, adjust device mechanical movements or perform other device adjustments.

For instance, the device can refer to a screen that is configured to display health information such as PHI. As such, based on a security vulnerability score that indicates the screen is susceptible to a degree of risk that is greater than a predetermined threshold risk degree, the device can undergo an automatic adjustment such that the screen orientation is automatically re-oriented in a different direction, the screen is automatically powered down or placed into a screen saving or locking mode, an actuator physically moves the direction or location of the screen to ensure display is not viewable any longer to a user, or other such adjustments can automatically occur. Accordingly, device adjustment platform 180 can employ one or more module(s) that can provide automated adjustment of several select devices in concert and belonging to several organizations.

In an aspect, device adjustment platform 180 can employ sourcing module 110, determination module 120, scoring module 130, analysis module 140, and adjustment module 150 to facilitate performance of device adjustments. In an aspect, sourcing module 110 can be configured to receive device data corresponding to device components and device attributes of a device based at least on a device scanning system. In an aspect, device attribute data can include various attributes corresponding to a device. Attributes can include an orientation of the device (e.g., whether a screen is facing a direction that is viewable by an unintended viewer), usage of the device (e.g., how often an authorized user is in front of a screen and how often authorized user is absent in front of the screen), device runtime (e.g., time periods and time stamps of device execution), processor actions (e.g., identification of amount of processing and types of components executed by the processor throughout a period of time), device position within a room and security vulnerability of such position (e.g., device screens oriented towards public viewing sites such as windows), performance statistics of device (e.g., quality of processor, processor speed efficiencies, session lock activation capabilities, etc.), and other such device attributes.

In another aspect, at least some device data can be received by adjustment platform 180 via execution of sourcing module 110 and employment of scanning technology that can scan the device(s) 106. In an aspect, the scanning system or technology can scan device(s) 106 such as screens, servers, cloud environments, desktop computers and other such devices to identify and detect vulnerabilities that may arise from mis-configurations, system flaws (e.g., firewall issues, router issues, web server issues, application server issues, etc.). In non-limiting embodiments, the scanning system can implement authenticated scans, unauthenticated scans, or a combination of both such that the sourced device data can include service data, device configuration information, security patch information, and other such data.

As a non-limiting example, an initial scan of network systems of environment 100A can determine one or more factors for unauthenticated risks. The data collected from the systems can be stored in a relational database. A risk factor for each device based upon data content and usage can be applied to subsets of data. In an aspect, usage data corresponding to usage logs of each respective device can be collected and analyzed utilizing artificial intelligence systems and/or algorithms that can learn the utilization of the data. The artificial intelligence systems and/or algorithms can evaluate usage data for patterns that don't fit the conventional or expected usage of the data. For instance, a non-inclusive or unconventional utilization of data can be indicated by a change in access authorization, pattern of access change, changes in volume of data usage, speed of data calculations, use of a number of access points to access and use the data, and other such patterns. In an aspect, the number of events monitored within the data collection mechanism (e.g., using sourcing module 110) can change based upon environmental conditions, type of data, access points and data volume which can indicate vulnerabilities or risk of devices to security breaches. Furthermore, abnormalities from patterned usages can be stored at an abnormality data store (of a relational database) and assigned a risk value. Based upon the risk value, the system can execute actions to contain or limit the risk.

In another aspect, sourcing module 110 can employ vulnerability scanning technology that identifies risks related to various devices (e.g., web server, application server, etc.), data sets, and/or network assets (e.g., firewall, router, etc.). For instance, sourcing module 110 can dispatch a vulnerability scanning technology configured to scan data stores (e.g., relational database) that store physical data, process flow data, administrative data, technical flow data, procedural data, policy data, and other such data sets to determine various vulnerabilities of devices, systems, and/or environments. As an example, sourcing module can perform a vulnerability scan of process flow data that may indicate a collection process, storage configuration of a device (e.g., device misconfiguration), or transmission route of protected information is susceptible to vulnerabilities (e.g., hacking). As such, sourcing module 110 can source vulnerability data (e.g., diagnostic data) for use by other components of the system(s) disclosed herein.

Furthermore, sourcing module 110 can employ vulnerability scans over several periods of time. As such, sourcing module 110 can capture vicissitudes in vulnerability exposure which can be correlated and/or matched (e.g., in a relational database) to various threat-addressing operations (e.g., implementing a patch, reconfiguring devices, augmenting a system architecture, re-routing data or transmission flows, authentication implementation, firewall strengthening, etc.). Furthermore, sourcing module 110 can store various schemas configured to store relational vulnerability data into a curated database. In an aspect, the curated database of relational vulnerability data can correspond to vulnerability attributes, logs, or events captured during each vulnerability scan operation. Furthermore, the curated database of relational vulnerability data can also identify associations and dependencies between entities and vulnerability attributes where a physical object (e.g., server device), an event (e.g., attempted unauthorized breach of a server device), or a concept (e.g., type of attempted hack) can be specified as a relational model within a database.

In an aspect, sourcing module 110 can also acquire information about data, such as various attributes associated with the data. Furthermore, sourcing module 110 can generate metadata to retain and describe the attributes corresponding with the data. As such, sourcing module 110 can generate metadata representing an analysis of data that includes user interaction data (e.g., how often a user is detected in a proximity range of a display that presents PHI), query data (e.g., requests for PHI), physical device attributes (e.g., device position, adjustments to devices, typical data types accessed and displayed on a device display, typical types of data stored on a device data store, etc.). In other non-limiting embodiments, sourcing module 110 can curate sourced data (from various sources), based on identified data attributes and relational data models. Furthermore, such data curation can include the transformation of source data to curated data that comprises attribute data, identified characteristic data, location data (e.g., device location within an area, secure locational data, viewability of screens within a location, etc.), cross-reference relationships to other data, source data characterizations, data lifespan information, data updates, obsolescence status of data, and/or data annotations.

For instance, sourcing module 110 can scan device(s) 106 and data sources corresponding to device(s) 106, analyze the data for data characteristics and attributes, augment or curate the data with identified characteristics and attributes, and update metadata corresponding to the source data with updated data attributes. In another aspect, source module 110 can generate metadata to retain and describe acquired attribute and/or information corresponding to device(s) 106 and its respective vulnerabilities. In another instance, sourcing module 110 can apply pre-defined rules to prioritize the type of data for sourcing and/or curating, the subsets of data for updating, and/or the validating of data that indicates security vulnerabilities. In an aspect, sourcing module 110 can curate device data with characteristic data or attribute data that can include technical flow data, physical flow data, process flow data, organizational data, and/or policy data.

For instance, physical flow data can include information about physical attributes of device(s) 106 including location of screens, monitors, and access to secure areas. As such, if a screen that often displays PHI is oriented towards a view of the public (e.g., facing a window where others can walk by) then such orientation information, viewing angles from the public, physical location information relative to public view vantage points, and other such data can correspond to physical flow data that characterizes source data relating to the PHI. Furthermore, the physical flow data can include data sourced from detection sensors of device(s) 106 that detect time interval information about the presence of users or physical activity behaviors of users. Furthermore, such data can be analyzed and utilized by adjustment module 150 to implement adjustments to device(s) 106. In another non-limiting implementation, environment 100A can employ logical and physical sensors configured to detect and/or measure data volume usage. Furthermore, the sensor data can be evaluated based on statistical models to determine a normalized and/or statistical usage of data. Furthermore, the artificial intelligence systems and/or algorithms can determine patterns associated with the determined statistics. In some instances, the occurrence of increased usage or several changes to usage can indicate increased risk factors that can be addressed through management of the sensors.

In another aspect, technical flow data can be sourced by sourcing module 110 as well. In an aspect, technical flow data can include data representing the technical environment corresponding to device(s) 106 (e.g., linkages and functioning between sensors, controllers, machines to function in a target manner such as protect PHI from security vulnerabilities), data associated with vulnerability scans, data generated from technology tool utilization (e.g., tools for invoking routing and application development and management within a network of device(s) 106, management of protocol stacks within a network architecture, etc.), evaluation data associated with a distributed node operating system, configuration status data of device(s) 106, and other such technical flow data. In yet another aspect, sourcing module 110 can source process flow data representing collection data, storage data and transmission data associated with device(s) 106 or data associated with Electronic Protected Health Information (EPHI). In another aspect, sourcing module 110 can source administrative flow data representing policy data (e.g., rule sets), procedural data (e.g., organization of tasks, processes, data flow, etc.), contractual data, and training data corresponding to device(s) 106.

In a non-limiting implementation, sourcing module 110 can receive, and/or curate data from one device (e.g., user mobile device) and trigger an automated operation (e.g., using adjustment module 150) of a second device (e.g., device(s) 106 such as a screen or monitor being triggered to automatically orient in a different direction or power down a screen, or swivel based on a mechanical movement mechanism, etc.). For instance, sourcing module 110 can receive and curate data from a user physical activity monitor (e.g., fitness fob device), behavioral monitor (e.g., pedometer to detect steps during time intervals), devices to track duration and intensity (e.g., sedentary vs vigorous movement) of the device movement (when utilized by a user), posture-based movement (e.g., standing, sitting, etc.). In an aspect, sourcing module 110 can receive and/or curate data from device(s) 106 components such as a detection sensor that detects motion or the presence or absence of an object. In response to sourcing module 110 receiving data from user device(s) and/or device(s) 106, adjustment module 150 can trigger a movement of device(s) 106 or conduct an operation to mitigate a vulnerability associated with the received, curated, (and analyzed) data.

In another non-limiting embodiment, server device(s) 102 can include a determination module 120 configured to determine a baseline value corresponding to a security status of device(s) 106 based on device data. In an aspect, determination module 120 (executed by one or more processor of server device(s) 102) can facilitate a determination of baseline data of device(s) 106. In an aspect, baseline data can represent values of target attributes of device(s) 106, parameters of device(s) 106, and or operational performance indicators of device(s) 106 that can indicate a secure or unsecure nature of device(s) 106. In an aspect, determination module 120 can utilize data sourced (e.g., by sourcing module 110) that represents user behavior when interacting with a device.

For instance, determination module 120 can utilize sensor data (e.g., sourced by sourcing module 110 from a motion detection sensor) to determine the metrics corresponding to a user's presence or absence from a screen. For instance, a user that is physically absent from sitting in front of a screen for stretches of time, leave the screen vulnerable to public viewability. As such, the lack of a physical object (e.g., the user body) to block the visibility of a screen can leave the screen susceptible to viewing from unauthorized individuals. As such, determination module 120 can determine the viewability of the private content displayed on a screen (e.g., how much of screen area displays the content), the number of times the content appears in a particular location on the screen, the number of times and duration of times a user is actively detected in front of a screen displaying PHI, screen positioning relative to public viewing areas (e.g., windows facing public hallways, etc.), and other such key performance indicators.

Furthermore, determination module 120 can determine the time of days the user is most often away from the screen (e.g., using pattern recognition techniques as applied to the user behavior data and screen sensor data). In an aspect, system employed within environment 100A can evaluate the volume of data usage of one or more network device to determine insights into behavioral data corresponding to each network device. In an aspect, artificial intelligence systems and/or algorithms applied to data behaviors indicate risk patterns. For example, analysis module 140 can analyze device behaviors and operations corresponding to chunking of data on a direct data access machine. Furthermore, determination module 140 can determine that such chunking behaviors correspond to the occurrence of a data leak that needs addressing. Accordingly, adjustment module 150 can execute an automated operation to shut down the direct data access machine, restrict direct access to data on the direct data access machine, implement a patch to the leak, or perform other remediating activity.

In another aspect, determination module 120 can determine the presence of a reduction in visibility corresponding to changes in visibility data. Furthermore, analysis module 140 can analyze the change in visibility data and determine that a rogue encryption process attempting ransom ware activities are occurring. In an aspect, determination module 120 in combination with analysis module 140 can determine that data points corresponding to single access login events that evolve into data points corresponding to multiple access points can correspond to a malicious insider attempting to exploit one or more network device and/or access protected data. Furthermore, determination module 120 can determine account profiles associated with such single and multiple access points to inhibit access capabilities of such user account. Furthermore, in an aspect, systems employed herein can employ pattern recognition techniques utilizing artificial intelligence learning technologies along with machine learning classifications to provide insights to data exposure risks from insider user accounts and/or outsider user accounts that surpass a threshold risk level representing expected data exposures. In an aspect, determination module 120 can also determine threshold data values that can correspond to triggering events that initiate automated adjustments to device(s) 106. For instance, sourcing module 110 in connection with determination module 120 can determine baseline values that represent background data as to typical configurations, parameters, and functioning of device(s) 106 to indicate a typical low vulnerability status of a respective device(s) 106. As such, a screen may be determined to typically correspond to baseline data representing a display of PHI in the absence of an authorized user for ten (10) minute periods throughout each day.

However, determination module 120 can determine that a significant number of unauthorized users pass by a window where the screen displaying PHI (in the absence of an authorized user) is visible to such unauthorized users. As such, determination module 120 can determine a threshold value to indicate those periods of time where the screen can be triggered to automatically adjust based on achievement of such threshold value. As such, the threshold value can represent a time period during the day (e.g., when a user is detected to be absent or historically absent from the screen), attainment of a critical mass of unauthorized users detected to be in the a viewable vicinity of a screen displaying PHI, and other such threshold events.

As such, upon such triggering event occurring, server(s) 102 can transmit instructions to device(s) 106 to automatically employ (e.g., via adjustment module 150) an actuator to mechanically move the device(s) 106 or re-orient a screen of device(s) 106 such that the screen is turned to a protected viewing position (e.g., not visible to unauthorized users at such orientation). For instance, adjustment module 150 can automatically orient the screen to face the display towards the floor or a wall that is not viewable by unauthorized persons upon detecting that the screen is unattended by an authorized user for longer than a five-minute interval. As such, adjustment module 150 can employ an actuator to move or control a system or mechanism of device(s) 106.

In a non-limiting example, sourcing module 110 can source motion sensor data, image data (e.g., from a camera or video device), and medical record data in connection with determination module 120 to determine whether a screen is unattended by an authorized user and whether unauthorized users are in the vicinity of the unattended screen as well as the likelihood to which such unauthorized users can view the PHI (displayed via an EMR for example). Upon determination of such events presenting a vulnerable scenario and a vulnerability score being generated (e.g., by scoring module 130) that indicates a threshold vulnerability occurring, an actuator employed by a screen or monitor can make use of signals detected from a sensor (e.g., motion sensor) and determined to pose a vulnerability (e.g., using determination module 120) to regulate, control, move, and/or configure the orientation, location, and/or direction the screen is facing (e.g., using adjustment module 150). Furthermore, the sensor and actuator of device(s) 106 can utilize server device(s) 102 and determination module 120 to determine baseline values at which sensor data and image data typically present.

In another aspect, determination module 120 can utilize data from other device(s) 106, such as servers and other critical infrastructural devices, to determine baseline values corresponding to security statuses of device attributes such as communication protocols, wired communication protocols, signal ranges of wireless technologies, bandwidth attributes, resource constraint attributes, interoperability of security systems of respective device(s) 106, fragmentation of various architectures (e.g., heterogeneous architectures such as NIST Network of Things, AIOTI High Level Architecture functional models, etc.), and base line values of other such systems or attributes of device(s) 106 that can identify the security status of device(s) 106. In an aspect, determination module 120 can employ a data reduction processing tool to converge or aggregate data into formats useful for data coring tasks (e.g., by scoring module 130) or data sourcing tasks (e.g., performed by sourcing module 110). Also, the data reduction processing can maintain the integrity of original data while achieving smaller representations of high-quality data (e.g., removal of noisy data, unclean data with missing values, inconsistent data, etc.). As such, determination module 120 can employ data reduction techniques that can include data cube aggregation, dimension reduction (removal of irrelevant data attributes), and data compression to procure high-quality data for determination of a baseline security status.

In an aspect, a baseline security status can be determined (e.g., using determination module 120) using statistical evaluations (e.g., mean, median, mode, standard deviation, etc.) of various operations or functions of device(s) 106 over a period of time. Furthermore, several baseline values can be curated (e.g., using sourcing module 110 in connection with determination module 120) data from device(s) 106 that are evaluated and transformed into meaningful data such as percentage share of each node in a network of device(s) 106 that execute a system function, task, or control mechanism (e.g., screen actuators). Other indicators determined by determination module 120 using sourced or curated data can include a number of queries ran on each device(s) 106 including queries for PHI, and other such statistics. Other baseline values can be based on authentication operations, authorization operations, access control operations, availability operations, encryption operations, and other such operations of device(s) 106 that identify a secure nature of the system and devices.

Furthermore, in an aspect, determination module 120 can determine comprehensive baseline values corresponding to aggregate device(s) 106 nodes within intricate system architectures as baseline value of any independent device(s) 106 node in isolation and identify security aspects and adjustments that can be employed within respective nodes or any independent node. Furthermore, determination module 120 in connection with scoring module 130 (e.g., by generating a vulnerability score post automated adjustment) can determine the security impact of such adjustment on the entire environment or a particular device(s) 106. For instance, adjustment module 150 may adjust three monitor orientations by employing actuator movements to such monitors (e.g., device(s) 106). As such, such orientation adjustments may interfere with other device(s) 106 functioning in the environment (e.g., prevent orientation adjustments of other device(s) 106 proximally located to the adjusted monitors). Accordingly, determination module 120 can make determinations based on other devices in an ecosystem when determining baseline values of an individual device(s) 106.

In another aspect, server device(s) 102 can execute determination module 120 to determine baseline values for device components such as routers, gateways, power supplies, microcontrollers, microprocessors, physical ports, connectivity's, sensors (e.g., temperature, pressure, humidity, motion acoustic, chemical, etc.), actuators, devices that manage other devices (e.g., networks, etc.), devices that interface with other devices (e.g., devices that act as an aggregator among other devices such as platforms), embedded systems and devices (e.g., smartphones, storage databases (e.g., data stores at rest, in transit, in use, etc.), device networks that exchange data (e.g., PHI) and information with other devices within the network in accordance with spatial coverage, data mining models that transform collected data into defined structures for further uses, and other such baseline values. Furthermore, determination module 120 can determine baseline values corresponding to various functions and tasks performed by such components such that comparison can be made to such baseline values to ascertain vulnerabilities and securities within independent device(s) 106 and across system architectures.

In a non-limiting embodiment, determination module 120 can determine a baseline value that is a representation of the real-time or current security vulnerability status of one or more device(s) 106 and/or systems employed by one or more device(s) 106. For instance, in a non-limiting embodiment, a determined baseline value can represent sensor functionality of device(s) 106. For instance, a baseline can correspond to a sensor output value when the sensor is not exposed to a stimulus (e.g., a user is absent from a range of detection of the sensor). As such, during a gradual change or dramatic change in the sensing system's output, the drift from the baseline can be determined (e.g., using determination module 120) and upon the drift reaching a threshold value, an automated adjustment can be triggered of the device(s) 106 (e.g., automated orientation of the screen change, automated power down of screen display, seizing to display PHI, etc.).

A baseline value determined using determination module 120 can enhance the ability of analysis module 140 to initiate targeted queries to procure insights into vulnerabilities associated with particular computing environments, processing devices, storage devices, security frameworks, network devices, operating systems, and/or applications. For instance, in an aspect, determination module 120 can determine a baseline value associated with each user profile stored in an access log related to a first data set that can provide a non-permissive access to a vulnerable data set. Furthermore, scoring module 130 can assign such user profiles a score that indicates a threat level based on various attributes (e.g., associated with unauthorized device, access times outside of a normative time range, newly created credentials, etc.). Furthermore, analysis module 140 can query information related to such user profiles to verify the reasonableness of the threat score.

Furthermore, in a non-limiting aspect, analysis module 140 can develop device profiles based upon device usage data and detected device usage attributes over a specified period of time. The device profile can be used to generate one or more usage pattern for storage in a system data store (e.g., relational database). In an aspect, each device profile can comprise data logs, system logs, network logs, and other data subsets (e.g., events, objects, attributes) and pattern can be generated from such logs and data based on chunking the data into logical profiles that are compared to baseline data profiles. Furthermore, patterns can be generated by device adjustment platform 180 that represent changes in system characteristics and changes to user access events can be that can be compared to respective baseline data. Also, device adjustment platform 180 can employ analysis module 140 to employ artificial intelligence logic to compare patterns associated with different data subsets and device profiles to generate risk profiles that can trigger adjustment module 150 to execute automated actions in milli-seconds to address the occurrence of risk profile values greater than threshold risk profile values.

Based on such verification of threat, adjustment module 150 can trigger the execution of a vulnerability mitigating operation. For instance, blocking the user credentials from accessing a data set. As an example, the user credentials can be matched with a structured relational database that denies access privileges corresponding with a particular device, IP address, user profile, badge identifier (e.g., barcode, QR code, scan code, etc.). Furthermore, adjustment module 150 can execute an automated restriction of privileges to particular devices, systems, and/or applications based on a level of privileges commensurate with the risk of the suspicious user account. For instance, adjustment module 150 can assign (e.g., downgrade access privileges) unprivileged access credentials to a suspicious user account. In yet another aspect, adjustment module 150 can disable administrator access credentials distributed amongst target workstations that may be susceptible to vulnerabilities.

In another instance, adjustment module 150 can trigger an automated deployment of software fixes or patches to system-specific and/or device specific vulnerabilities (e.g., patching operating systems). Furthermore, various subsets of data stored on a device can correspond with a respective lifespan and an identifiable pattern. In an aspect, systems disclosed herein can employ artificial intelligence logical models that can learn such patterns associated with subsets of data and input the respective pattern into a data store having a data structure or data model configured to classify each respective pattern. Upon an identification of a change in data pattern, a new signature and new pattern can be generated that can again be logged as an event and mapped to a data store for classification. Some signatures can indicate particular threats (e.g., ransom ware), and such signatures can also create new data signatures. When a data signature is applied to an at-risk data signature (e.g., at-risk of creating new data signatures) then a risk rate or higher-level risk value can be assigned to such data signature. Furthermore, adjustment module 150 can execute an automated action based on the risk value and data signature determined. In an aspect, the flow of data usage corresponding to respective device(s) can be the basis for generation of the signature that can be compared to the signatures stored at a risk data store. The comparison of such data flow signatures and risk signatures can serve as the basis for performance of automated adjustments by adjustment module 150. Furthermore, device adjustment platform 180 can employ artificial intelligence logic to learn and compare signatures across multiple users, multiple devices, multiple logic networks and multiple organizations. Furthermore, such large and increasing volume of signature data can be utilized to train machine learning models in identification and grouping of signature data sets. Furthermore, hyperparameter tuning of machine learning models can employ hyperparameter adjustments based on such signature learning mechanisms.

In another instance, determination module 120 can determine a baseline value that represents electrical pulse signals received from the motion sensor under conditions when a user is positioned in front of the monitor or screen. Furthermore, determination module 120 can determine a baseline value corresponding to a particular pattern configuration associated with the motion sensor conditions in the absence of a user or in the presence of an authorized user. As such, the detection of drift from baseline value can indicate a presence or absence of a user from the screen. In other aspect, determination module 120 can determine baseline values for changes in detectable output signals (e.g., to determine if there is a security concerning noise amount applied to a sensor signal), interference signals, accuracy of sensing result outputs, efficacy of calibration to sensing systems, sensitivity of changes to sensor outputs in response to sensor input changes (e.g., detection of objects), ability of a sensing system (e.g., and sensor employed by device(s) 106) to measure a target in the presence of various interferences (e.g., detect presence or absence of a user in an environment where other people are moving within the range of the sensors sensing faculties), a sensing systems response to dynamic changes in an environment around device(s) 106.

In another aspect, server device(s) 102 can execute scoring module 130 configured to generate a score for assignment to various data sets (e.g., stored in one or more structured relational database) such that the score represents a relative level of risk corresponding to a set of data. Furthermore, in an aspect, scoring module 130 can generate a vulnerability score that triggers adjustment module 150 in connection with automated controller module 184 to calibrate the motion sensor if a pattern of electrical signals is determined to vary from a pattern of signals corresponding to a typical secure scenario. In another non-limiting embodiment, device(s) 102 can comprise scoring module 130 configured to generate a security vulnerability score of the device based on a comparison of the baseline value to a threshold value representing security vulnerabilities of the device components and the device attributes. Accordingly, scoring module 130 can establish threshold values that indicate a security vulnerability is beyond a tolerable level such that adjustment module 150 can employ an automatic adjustment of a device to mitigate or reduce such security vulnerability or threat.

As an example, scoring module 130 in connection with determination module 120 can determine that a screen positioned at a viewing angle that is perfectly aligned with a window in public view is substantially vulnerable to security threats whereas a screen positioned at an angle that is partially viewable through a window in public view is less of a security threat because it is more obfuscated from public viewing. Accordingly, a detection sensor of device(s) 106 can detect when a screen is positioned at more vulnerable angles. Particular angles of screen orientation and positioning can correspond to particular values and beyond a particular orientation can be considered a threshold value. Upon a detection that a baseline value (e.g., determined by determination module 120) has equaled or exceeded a threshold value (e.g., determined by scoring module 130 in connection with determination module 120), then adjustment module 150 can trigger an automatic adjustment of the screen orientation (e.g., by activating an actuator of the screen to physically turn the screen direction).

In an aspect, scoring module 130 can determine threshold values for several security vulnerabilities and compare such threshold values to any relevant baseline values for such device(s) 106 and its attribute, function, component, or other device characteristic. As an example, determination module 120 and scoring module 130 can determine baseline values and threshold values that correspond to device or hardware failures, system failures, network outages, support service losses, physical attacks on device(s) 106 (e.g., device modification, device destruction, etc.), advanced persistent threats, identification of counterfeit operations by malicious devices, information modification (e.g., jamming sensors), attacks on privacy (e.g., abuse of personal data), data leaks, system configuration errors, authentication weaknesses, and other such vulnerabilities. Furthermore, scoring module 130 can compare baseline values to threshold values to effectuate an automatic adjustment of device(s) 106 screens via adjustment module 150.

In another aspect, device(s) 102 can employ analysis module 140 configured to compare the security vulnerability score to a lower security vulnerability score corresponding to another device that is different from the device(s) 106. In an aspect, analysis module 140 can facilitate a comparison of security vulnerabilities amongst device(s) 106 within an environment to determine (e.g., using determination module 120) overall security vulnerability scores for the environment. Furthermore, analysis module 140 can perform query analysis to extract information from curated data (e.g., sourced and curated by sourcing module 110) and procure insights corresponding to the device(s) 106 and respective security vulnerabilities. For instance, analysis module 140 can receive a query of a security issue from administrator computing device(s) 104 and analysis module 140 can query a data store based on such query request. Furthermore, analysis module 140 can execute queries that correspond to target topics of inquiry and/or identify contextual data corresponding to such topics. Furthermore, analysis module 140 in connection with sourcing module 110 can scan device(s) 106 to retrieve characteristic data, topic data, physical data, process data, and other such data sets to satisfy the query request. As such, analysis module 140 can dispatch queries to gather a range of data (e.g., representing physical and logical events) evidencing a device or assets exposure to threats or exploitations.

In another aspect, analysis module 140 can trigger a query based on an occurrence of various events. For instance, analysis module 140 can trigger a query to access and analyze device(s) 106 data (e.g., monitor orientation data) based on scoring module 130 indicating that a base value reached or exceeded a threshold value. In an aspect, analysis module 140 can analyze and compare security vulnerability scores between device(s) 106 to analyze various security vulnerabilities such as vulnerabilities against network links between controller devices and actuators (e.g., of screens), associated with sensor modifications and threshold values and setting vulnerabilities, associated with modifications of actuator settings, associated with device power source manipulation, and other such vulnerabilities.

In another non-limiting embodiment, device adjustment platform 180 can employ adjustment module 150 configured to automatically adjust the device attributes or the device components to match at least another device attributes or another device component to decrease the security vulnerability score. In an aspect, adjustment module 150 in connection with other modules (e.g., scoring module 130, etc.) can perform automated adjustments to device(s) 106 to reduce vulnerability scores and lower vulnerabilities, threats or risks to device(s) 106. As an example, adjustment module 150 can communicate (transmit data) with device(s) 106 through electronic coupling with the processor of device(s) 106, cause an actuator component to automatically move a screen in a direction determined (e.g., using determination module 120) to procure a lower vulnerability score. In other embodiments, adjustment module 150 can transmit data (e.g., instructions) to device(s) 106 to control the power capabilities of device(s) 106 to automatically power down a monitor in response to a triggering event (e.g., baseline value determined to be greater than a threshold value) in order to mask the presentation of PHI during vulnerable periods of time.

In another aspect, adjustment module 150 can automatically adjust physical components of device(s) 106, attributes of executable systems operatively connected to device(s) 106, devices that interface with other device(s) 106, devices that manage other devices, smartphones, tablets, gateways, firmware, information, and other such items based on an occurrence of a vulnerability score having a respective threshold value. For instance, a generated vulnerability score (e.g., using scoring module 130) can indicate that calibration parameters for sensors electronically coupled to device(s) 106 are being manipulated or are susceptible to manipulation and as such analysis module 140 can query sensor processing systems, data and control systems to determine whether the sensors have endured a configuration change that has had detrimental or positive effects on the vulnerability exposure of such device(s) 106 sensors. Furthermore, adjustment module 150 can automatically reconfigure or adjust the calibration parameters of such sensor to achieve lower vulnerability scores. Furthermore, adjustment module 150 can automatically reset access configurations to such control and processing systems based on the occurrence of a threshold vulnerability score being detected (e.g., mitigates sensor malfunctioning or manipulation).

In another aspect, adjustment module 150 in connection with analysis module 140 can query network device(s) 106 based on detected or perceived breaches to a processing and/or control system of device(s) 106. Furthermore, adjustment module 150 can execute operations that provide greater security to such control systems based on the detected or perceived breaches. For instance, a bad actor device may execute administrative tasks with administrative device that control device(s) 106 in order to cause device(s) 106 malfunctions. As such, analysis module 140 can query (e.g., based on a vulnerability score greater than a threshold score) a logging system of the administrative device(s) to detect unauthorized or suspicious log data. Furthermore, adjustment module 150 can automatically transmit data to the administrative device to change and/or reset permissions, authentication mechanisms, logging systems, security rules, and other adjustments to lower the vulnerability score.

In yet another aspect, adjustment module 150 can execute operations or commands to execute operations to mitigate respective vulnerabilities. For instance, if a suspicious user has access to a target device storing data for authorized users, then adjustment module 150 can add, modify, or remove access credentials of such suspicious user to prevent access to the target device. In a non-limiting aspect, adjustment module 150 can modify or remove a license (from a memory store of the target device), such as a string of terms corresponding to a license registration entry, where such removal prohibits the suspicious user to access the target device. I

In another aspect, server device(s) 102 can employ database(s) 160. Database(s) 160 can be one or more data store that stores curated data, sourced data (e.g., using sourcing module 110) or other such information that is extracted, analyzed, evaluated, and/or acted upon by server device(s) 102 and corresponding modules. As an example, data sourced (e.g., using sourcing module 110) from several device(s) 106 can be stored in database 160 and curated according to classifiers, machine learning algorithms, and other data structures as well as organizational frameworks (e.g., relational models). In an aspect, a data structure can include any one or more structural types that allow data to be stored, retrieved, and/or defined. As such, a data structure can include trees, queues, stacks, arrays, strings, containers, lists, graphs, bitmaps, heap objects, linked-lists, matrices, function parameters, files, and other such structures. In an aspect, sourcing module 110 can exchange data with device(s) 106 based on rule sets that define data structures to allow cross-entity data sharing, such as data sharing amongst distributed device(s) 106. Furthermore, adjustment module 150 can execute repeatable automated adjustments of various device(s) 106 by different entities to achieve target results (e.g., lower vulnerability scores) sometimes based on data structure parameters. Also, adjustment module 150 can execute automated commands among different entities to mitigate various vulnerabilities.

In yet another aspect, server device(s) 102 can comprise first communication module 170 that communicates with external devices. In an aspect, first communication module 170 can represent a combination of hardware, software, and/or firmware configured to facilitate the exchange of information such as sensor data, video data, location data, custody data, identity data, condition data, scheduling data, media data, audio data, text data, command data, query data, message data, device(s) 106 data device adjustment platform data, and other such data. In a non-limiting embodiment, first communication module 170 can include one or more protocol stacks associated with a network (e.g., network component 114) over which data can be exchanged and/or firmware can be employed to process messages used in maintaining a wireless or wired communication session and perform other such operations.

In other non-limiting embodiments, first communication module 170 can include computer networking ports, such as an Internet Message Access Protocol (IMAP), a Transmission Control Protocol (TCP) port, a User Datagram Protocol (UDP) port, a Hypertext Transfer Protocol (HTTP) port, a File Transfer Protocol (FTP) port, or other such ports. In other non-limiting embodiments, first communication module 170 can include physical communication ports, such as a serial port, an audio port, a keyboard port, a display port, a parallel port, a Universal Serial Bus (USB) port, and other such physical ports. In one or more implementations, first communication module 170 can be used by server device(s) 102 to connect with other devices such as computing device(s) 104 and/or device(s) 106 via network component 114.

In other non-limiting embodiments, environment 100 can include network component 114. In a non-limiting embodiment, network component 114 can generally represent any suitable type of communication network such as cloud computing networks that facilitate a bi-directional link between various computing devices. In an aspect, network component 114 can include more than one interconnected communication networks that comprise a plurality of interconnected elements, such as Ethernet access and wireless local area network (WLAN), a wireless telecommunication network interconnected with the Internet, a wireless (e.g., Wi-Fi) access point connected to the Internet, an Internet of Things (IoT) network (e.g., smart label device network), and other such communication networks or interconnected elements. In another non-limiting embodiment, server device(s) 102, computing device(s) 104, and smart label device(s) 106 can communicate over network component 114.

In non-limiting embodiments, device(s) 106 can employ transmission module 182, automated controller module 184, and/or a machine capture module 186. In an aspect, transmission module 182 can be configured to transmit device data corresponding to device(s) 106 components and device(s) 106 attributes of the device based on a request of a device scanning system. As such, transmission module 182 can transmit data to server device(s) 102 in response to a request for data from device(s) 102. Furthermore, in an aspect, device(s) 106 can receive data from other network device(s) (e.g., adjustment module 150) such as data representing instructions to perform an automated adjustment to mechanical components of device(s) 106. In some non-limiting embodiments and implementations, automated adjustments can also be utilized in connection with evaluating the execution of such physical device automated adjustments to Health Insurance Portability and Accountability Act (HIPAA) security rules, National Institute of Standards and Technology (NIST) guidelines, and other protocols.

In another aspect, device(s) 106 can employ automated controller module 184 that can automatically adjust at least one of a device(s) 106 orientation, a device(s) 106 screen display setting, a device(s) 106 physical position or location, or a device(s) 106 camera span of view based on control data or configuration data received from an automated control system (e.g., adjustment module 150 of device adjustment platform 180). In an aspect, automated controller module 184 can employ an actuator to convert an electrical input into a physical action. For instance, automated controller module 184 can receive an electrical input based on occurrence of a trigger event (that indicates a vulnerability score is beyond a threshold) that automatically has an actuator change an orientation of a monitor or screen.

For example, a screen can be determined to be in public view based on a sensor or transducer that converts a detection (detection of a user absence from being positioned in front of the screen) event into an electrical impulse that can be interpreted by determination module 120 in connection with scoring module 130 to generate a vulnerability score that requires an automated adjustment (e.g., using automated controller module 184) of the screen position or orientation. As such, a physical hydraulic system, electric motor, pneumatic system or other mechanical components can be employed by a screen or monitor or other device(s) 106 to automatically move the position of the screen to present a lower vulnerability score. In an aspect, automated controller module 184 can perform automated adjustments on several different device(s) 106 based on various sensing components.

For instance, sensing components of various system embodiments can sense attributes such as device acceleration, tilt, sounds, vibrations, humidity's, temperatures, motions, velocities, displacement, proximity, positions, presence, machine vision, optical attributes, and other such attributes. In another aspect, automated controller module 184 can control actuators on device(s) 106 that can perform automated movements including valves, power screws, electromechanical switches or jacks (e.g., protect various devices from voltage, current, or thermal overloads), guides (e.g., mechanical devices used to position or move objects such as screen orientation with high degrees of accuracies and repeatability), hydraulic cylinders (e.g., pistons and rod assemblies actuated by incompressible fluid pressure), and/or pneumatic cylinders (e.g., mechanical devices consisting of pistons and rod assemblies housed within cylindrical boars that can be actuated by air). In another aspect, automated controller module 184 can perform automated adjustments to other device(s) 106 such as servers by controlling actuators and dispatchers to control methods of coexisting, clustering, and/or impacting other server devices (or nodes). Furthermore, automated controller module 184 can employ automated adjustments to actuators of servers that can configure maximum concurrent request numbers, maximum request admitting rate, influence resource allocations within a server, and other server control variables.

In another embodiment, device(s) 106 can employ machine capture module 186 that employs sensors and/or machine vision technologies to detect conditions that impact the security of one or more device(s) 106 within environment 100. In an example, machine capture module 186 can utilize camera devices affixed to device(s) 102 or located in the surrounding area of device(s) 102 to monitor the environment and detect various events related to security or vulnerability that may occur in such area. For instance, a machine capture module 186 can employ cameras to capture the movement of users or public viewers capable of viewing a monitor. Furthermore, such image or video data can be extracted (e.g., using sourcing module 110) and analyzed (e.g., using analysis module 140) for predictive data that can be utilized by learning algorithms (e.g., machine learning models) to determine baseline values and security scores related to such information.

In another implementation, computing administrator computing device(s) 104 in connection with client device adjustment module 190 can employ display module 192, input module 194, and/or client smart label module 196. In an aspect, display module 192 can facilitate user device controls of analytics operations, query operations and other such operations of employed by server device(s) 102 and facilitate display of such operations at a user interface of administrator computing device(s) 104. In another aspect, input module 194 can provide a user access into features provided by device(s) 106 such as analyzing sensor data or other data of device(s) 106, accessing chain of custody and/or chain of identity data, and/or tracking of transactional data related to device(s) 106 and/or server device(s) 102, and other such activities.

In another aspect, administrative computing device(s) 104 can employ second communication module 198 configured to communicate with server device(s) 102 and respective modules employed by server device(s) 102. Furthermore, second communication module 198 can represent any suitable combination of hardware, software, and/or firmware configurable to facilitate data exchanges, instruction exchanges, rule exchanges, and other communication exchanges with other devices (e.g., server device(s) 102 via first communication module 170). In an aspect, administrator computing device(s) 104 can employ client device adjustment module 196. Client device adjustment module 196 to transmit data, instructions and in some aspects control operations of modules employed by server device(s) 102. Furthermore, in an aspect, client device adjustment platform 190 can facilitate the interaction with several server device(s) 102 and configure as well as control several server device(s) 102 simultaneously.

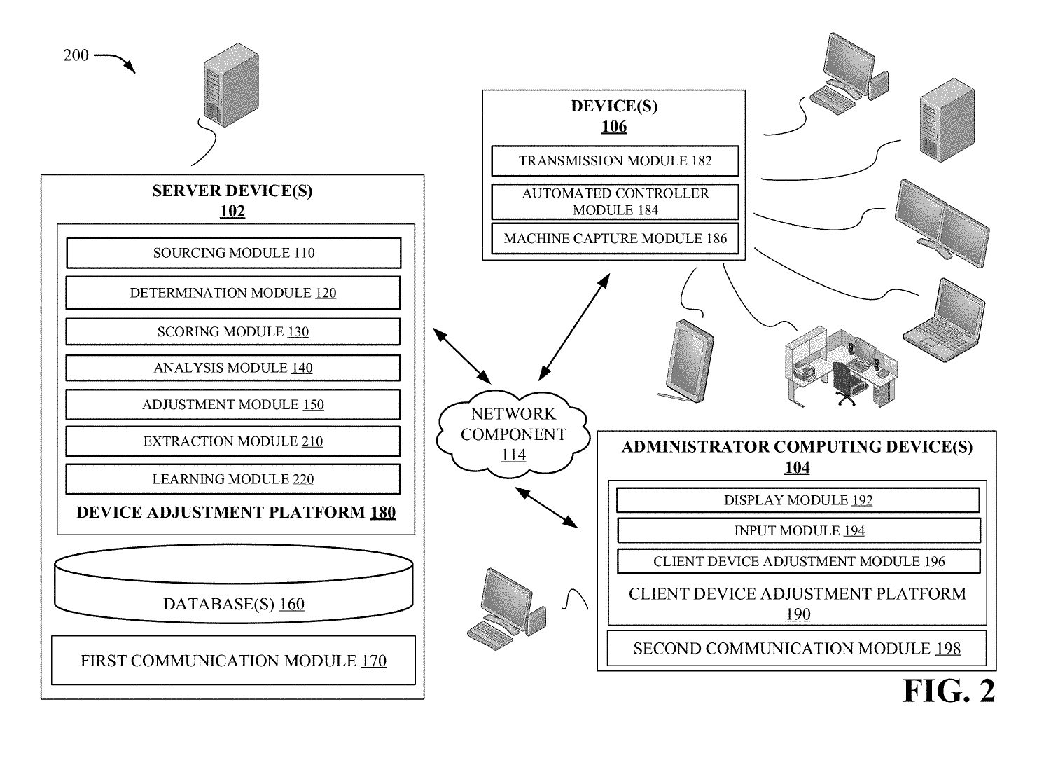

Turning now to FIG. 2, illustrated is a block diagram of an example, non-limiting environment 200 in which vulnerability insights can be generated from a machine learning algorithm based on the extraction of machine learning parameters from another machine learning algorithm in accordance with one or more embodiments described herein in accordance with one or more embodiments described herein. Repetitive description of like elements employed in other embodiments described herein is omitted for sake of brevity.

In a non-limiting embodiment, server device(s) 102 can employ device adjustment platform 180 in connection with extraction module 210 to extract machine learning parameters applied to a set of device attribute data and a set of device component data corresponding to a set of devices with security vulnerability scores above the threshold value. In an aspect, server device(s) 102 can utilize machine learning systems to recognize patterns based on machine learning operations applied to anecdotal data of device(s) 106. Furthermore, based on such machine learning recognized patterns, the system can determine (e.g., using determination module 120) baseline values of security attributes of device(s) 106, generate more accurate vulnerability scores (e.g., using scoring module 130) of device(s) 106 during operations, and determining triggering events (based on recognized patterns procured from machine learning insights) that facilitate adjustment module 150 in connection with automated controller module 184 to perform an automated operation (e.g., execution of actuator to move orientation of a monitor, shutdown power to a monitor, configure or modify server dispatch configurations, etc.).

In an instance, environment 200 may employ machine learning systems that evaluate vulnerabilities of several client entities having similar key attributes to one another such as clientele, type of protected data, industry, and/or technology utilized (e.g., vendors, firewalls, detection systems, operating systems, cloud computing vendors, content delivery networks, security services providers, etc.). As such, a vulnerability, threat, or attack that attacks one client entity can likewise affect other client entities. Accordingly, embodiments of systems and devices herein can share vulnerability mitigating techniques and risk exposures among a set of clients without exposing the underlying private data of any particular client.

As such, vulnerabilities correlated with similar attributes between respective client entities can be determined using machine learning technologies. Furthermore, in an aspect, client entities with shared attributes can be aggregated into clusters to locate groups of client entities with shared attributes. The cluster of client entities can be grouped based on having a low diversity score based on the similarity level of the shared attributes. In an aspect, several thousand attributes can be analyzed, and the vulnerabilities correlated with such attributes can be evaluated for insights. For instance, a variable such as firewall configuration or type of routine used to tabulate an event log can be determined to allow for the access to protected data in several client entities. In various aspects, the shared attributes can be localized or generalized to particular environments. Accordingly, a machine learning model can be utilized to perform and/or improve predictive or inferential analysis of vulnerabilities and/or security threats associated with various environments, devices, and/or systems of respective client entities.

In various non-limiting embodiments, sourcing module 110 can source and/or curate device(s) 106 data. Furthermore, sourcing module 110 can apply machine learning algorithms, data mining algorithms, and/or Principal Component Analysis (PCA) algorithms to sourced or curated security data and/or attribute data to procure vulnerability data and generate vulnerability insights associated with one or more device(s) 106 corresponding to one or more client entities. The machine learning algorithms and systems can utilize learned insights from a first device(s) 106 via parameter extraction that can be applied to machine learning models and algorithms applied to second device(s) 106 that are not the same as first device(s) 106.

Furthermore, in some non-limiting embodiments, extraction module 210 can determine weighting, variables, and hyper-parameter adjustments using acquired knowledge sourced from sourcing module 110 to use machine learning to execute determinations regarding system and device vulnerabilities. For instance, sourcing module 110 can employ machine learning technologies to predict the probability of upcoming cyber-attacks occurring, risk of device failures, risk of security or safeguard failures from occurring, and other such vulnerabilities. As an example, extraction module 210 can adjust parameters, weights applied to variables, and schemas that are appropriate to a particular type of client entity such as a hospital class, insurance group, medical provider type, or other type of client grouping such that a group of peer data can be aggregated, curated, and analyzed to procure vulnerability insights.

In some respects, the extraction module 210 allows for the procurement of vulnerability determinations tailored to a particular circumstance, preference, or other such factor. In other aspects, machine learning algorithms employed by sourcing module 110 can predict various outcomes or sets of possible outcomes to occur based on an implementation of one or more action or command by adjustment module 150. In another aspect, the tracking of data usage events can allow device adjustment platform 180 to identify data usage similarities within a respective type of environment. In some instances, each environment can be defined by the data access patterns rather than a business vertical. Furthermore, similarities in data access patterns can be identified by device adjustment platform 180 based upon the type of device.

The type of device can be a workstation human driven, a database server with data delivery or a network device with network traffic patterns. Data events from visional aspects and usage can create patterns. Each functional device can create a data signature generated by artificial intelligence algorithms. The data signatures can be created utilizing log data, data processes, programming access data, and/or event data. Furthermore, artificial intelligence technologies can be employed to determine and detect differences in data at rest and data in motion based on differences in motion characteristics of data at rest as compared to data in motion. Furthermore, artificial intelligence algorithms can determine and detect similarities in device(s) and device data that are shared across multiple organizations. Furthermore, as the volume of organizations analyzed increases, the number of patterns identified increase and the artificial intelligence technologies can become more proficient and accurate in identifying the respective patterns.

Accordingly, various implementations can facilitate the abstraction of vulnerability data, attribute data, and other such device data from underlying private client entity data used for extraction (e.g., using extraction module 210) of variables, parameters, weights, and/or hyper-parameters to teach the machine-learning algorithms to perform more accurate predictions and insights based on an abstracted pool of relevant data from a pool of client peers. In an aspect, device adjustment platform 180 can employ extraction module 210 to extract such machine learning parameters and/or hyper-parameters and apply them to machine learning models applied to other devices to facilitate the sharing of machine learning insights. As a consequence, the prediction of security vulnerabilities and implementation of automated adjustments to the device(s) has greater efficiency, greater speed, greater accuracy and stronger security protection than in the absence of the machine learning insight sharing.

Also, as a result of extraction module 120 iteratively performing hyper-parameter optimization operations, the system can employ training operations for various machine learning models using more accurate and relevant data and meta data over a continuous feedback loop that procure high quality quantitative metrics and feedback metrics to generate better vulnerability insights. Furthermore, vulnerability data input into each machine learning model can be mapped to particular subsets of vulnerabilities (e.g., vulnerability to firewalls, vulnerability to servers and other devices, vulnerability to unauthorized user access of protected data, vulnerability of information threats due to physical asset locations, etc.) and cross-correlated to determine an overall vulnerability score.

In another aspect, device adjustment platform 180 can employ learning module 220 configured to iteratively apply the extracted machine learning parameters to another machine learning algorithm or model applied to data corresponding to another device. As such, learning module 220 can apply machine-learning algorithms and/or models to determine the insights and/or combine the results of multiple data extractions into insights that are used as a basis for generating an automated adjustment to device(s) 106 or several device(s) 106 with greater efficacy and more secure outcomes. This can include using and adjusting hyper-parameters associated with the machine-learning algorithms, such as those further described herein. In an aspect, learning module 220 can apply a hyper parameter extracted from a first machine learning algorithm acting upon a first device to second machine learning algorithm acting upon a second device (different from the first device) using transfer learning methods. As such, hyper parameters from several machine learning algorithms can be extracted and applied in various combinations and permutations to machine learning algorithms acting on target device(s) 106 based on the machine learning systems gaining insights over time.

In an aspect, learning module 220 can employ hyper-parameter tuning operations such as grid searching, to search for an array of possible combinations of values for hyper-parameters corresponding to vulnerability attributes (e.g., device configurations, physical asset configurations, application fixes, number of access requests to protected data in a time period, and other attributes) within an environment. Furthermore, the combinations of values can be used to construct various versions of machine learning models with various combinations of hyper-parameter values to identify a set of vulnerabilities within a particular confidence interval. In another aspect, learning module 220 can employ random searching techniques to determine hyper-parameter tuning activities for a respective machine learning model generation.

In yet another aspect, device adjustment platform 180 can employ generation module (not shown in FIG. 2) configured to generate vulnerability insights from the machine learning algorithm based on the extracting machine learning parameters in connection with the machine learning algorithm. In an aspect, the machine learning algorithms can be applied to large volume of vulnerability data sourced from data stores and device(s) 106. Furthermore, extracting accurate, current, and reliable insights is insurmountable from a manual perspective. As such, generation module can utilize machine learning models and algorithms to extract data, identify trends, identify patterns, and in connection with generation module, generate insights from the trends and/or patterns.

In an aspect, the generated patterns can bear relevancy to particular device 106, vulnerability attributes of device 106, anecdotal data specific to the particular device 106 (e.g., particular user behaviors in association with a respective device(s) 106 that procures a device vulnerability), identified inference relating to device 106 or environment 100B, vulnerability identifiers or correlations, outliers, anomalies, trends, and other such insights. In various implementations, learnings procured from generation module (not illustrated in FIG. 2) can be extracted from a machine learning model applied to a first device and applied to machine-learning algorithms and/or models acting upon another device data to procure insights from other device data to generate or implement an automated adjustment instruction to device(s) 106. As an example, generation module can generate an insight that several device(s) 106 detect an absence of motion or users in front of a monitor displaying PHI between 1 pm-4 pm EST. As such, that insight can be generated and used to identify patterns associated with other display device(s) 106 as well as implement automated adjustment activities of monitor actuators to reduce the vulnerability of unauthorized PHI divulgation. In another aspect, learning module 220 can employ machine learning algorithms to make predictions from extracted data and identify trends and patterns to generate insights.

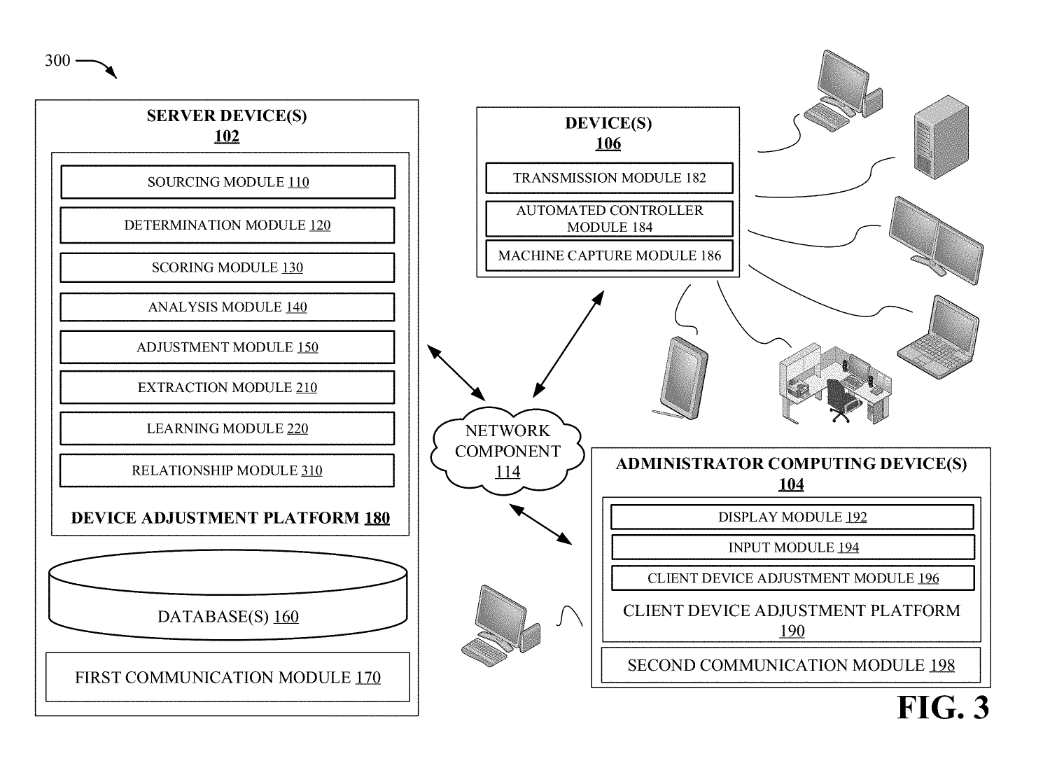

Turning now to FIG. 3, illustrated is a block diagram of an example, non-limiting environment 300 in which relationship models are generated between vulnerability insights and automated adjustments to device attributes or device components in accordance with one or more embodiments described herein. Repetitive description of like elements employed in other embodiments described herein is omitted for sake of brevity.

In a non-limiting embodiment, server device(s) 102 can employ device adjustment platform 180 in connection with relationship module 310 to identify data relationships between vulnerability insights (e.g., generated using generation module) and adjustments to the device attributes or the device components. In an aspect, relationship module 310 can identify a vulnerability topic and then specify a relationship model for such topic or domain. For instance, relationship module 310 can identify topics such as user negligence, data store safeguards (e.g., for PHI), hacking attempts or data breaches, visibility or sightlines of data to authorized staff, authentication mechanisms, and other such topics.

Furthermore, relationship module 310 can specify the relationship between various vulnerability attributes (e.g., vendor attributes, hardware attributes, infrastructure and architecture attributes, device configuration attributes, user behavior attributes, etc.) and automated adjustments to be implemented to overcome such vulnerability. In a non-limiting embodiment, adjustment module 150 can automatically shut down or remove a device, or machine from participation within an environment based on a determined risk level or vulnerability exposure corresponding to such machine. In another non-limiting embodiment, upon an occurrence of a user profile triggering a threshold risk level (e.g., determined to perform a sufficiently risk activity such as attempt to access an off-limit database), such user profile access privileges can be automatically removed or revoked by adjustment module 150. For instance, such license associated with the user profile can be assigned a flag that renders such license limited in access capabilities for performance. In another aspect, upon the occurrence, identification, or triggering of more than one risk event occurring, a more general access capability restriction of the network can be imposed by deactivating a physical device (e.g., automated powering down of an internet router device). In another aspect, adjustment module 150 can automatically deactivate offending devices upon an occurrence or identification of various identifiable risks as well. In an aspect, adjustment module 150 can automatically shut down or limit access to data delivery or storage in response to identification of an access risk. Furthermore, adjustment module 150 can terminate respective programs based on identification of a program running on a remote machine that creates spikes in CPU usage which can represent that the machine is processing data in an unexpected and risk-prone manner.

In various implementations, relationship module 310 can identify a model employing respective schemas to identify associations and dependencies between devices (e.g., devices in environment 300 such as device positions), events (e.g., absence of user detection by a monitor, poor result of a device scan, increased flow of unauthorized viewers in a vicinity that places devices in heightened vulnerability states), transactions, and other such associations. For instance, relationship module 310 can generate an entity-relationship graph that may automatically employ dynamic adjustments to device(s) upon an occurrence of one or more condition at each related device or entity. Furthermore, related entities may also inherit actions from a parent-entity based on an automated adjustment occurring. As an example, if a log event occurs by an unauthorized user, such access credentials of the unauthorized user may be revoked, and as such, the new limited access credentials may be propagated to an access privilege server, a firewall server, the BIOS of a device comprising license information, and other such related entities. Furthermore, a schema can include various techniques such as diagramming techniques including Unified Modeling Language (UML), Barker's notation, Extensible Markup Language (XML) schema, Backman notation, Object-role modeling (ORM), and other such techniques. Furthermore, in an aspect, the relationship model generated by relationships module 310 can be stored in a relational data model database such that vulnerability data, device data, attribute data, anecdotal data, and other such data can be integrated, mapped and related according to a structure that allows for an efficient and accurate identification of vulnerabilities. Furthermore, the relationships can be used by various modules to automatically trigger adjustments (e.g., using adjustment module 150) to device(s) 106 based on insights procured from the relationships.

In another aspect, the implementation of machine learning models and implementation of hyperparameter setting optimizations (e.g., quantify the importance of a single hyperparameters and/or interactions between hyperparameters) on an iterative basis to solve individual or combinatorial problems generate faster identification of vulnerabilities to systems and devices within environments disclosed herein. Furthermore, such optimizations and machine learning models can generate faster execution of vulnerability identification, automated device adjustments, and vulnerability mitigating operations than in the absence of such machine learning models.

Furthermore, processors within the environments disclosed herein can process respective operations such as early termination of bad runs of vulnerability assessments, implementation and adjustment of vulnerability recognition benchmarks, increase speed of optimization methods by utilizing the hyperparameter optimizations and machine learning techniques disclosed herein in combination with automated adjustments of devices. Furthermore, in an aspect, various vulnerability scans can be terminated early if such scan is determined to be a bad run early on. As such, learning curves and probabilistic approaches used to identify vulnerabilities via machine learning mechanisms can save time and free up processors for utilizations in other operations therefore increasing the speed of the entire system architecture within environments disclosed herein.

In yet another aspect, machine learning techniques disclosed herein can implement iterative pruning or fine-tuning techniques that identify vulnerabilities in each iterative execution of input data to be executed by the machine learning model to decide which layers of a deep neural network predictive model that identifies energy consumption of memory operations utilized to identify system and device vulnerabilities in respective environments disclosed herein. For instance, the memory associated with various device(s) that provide access to protected health information data may consume a quantity of energy based on a memory access pattern (e.g., energy to access a register file, energy to perform a global buffer operation, energy to access a main memory, etc.) to perform the access-permission operation to grant a user profile access to privileged data. Furthermore, if various memory access patterns are associated with a high vulnerability user profile, such access can be denied to such user profile prior to undertaking high energy consuming memory access operations using predictive vulnerability detection techniques employed by systems disclosed herein. As such, the systems and methods disclosed herein can increase processor speed and memory efficiencies by employing or cutting short memory access operations related to identified vulnerable device(s) or profiles.

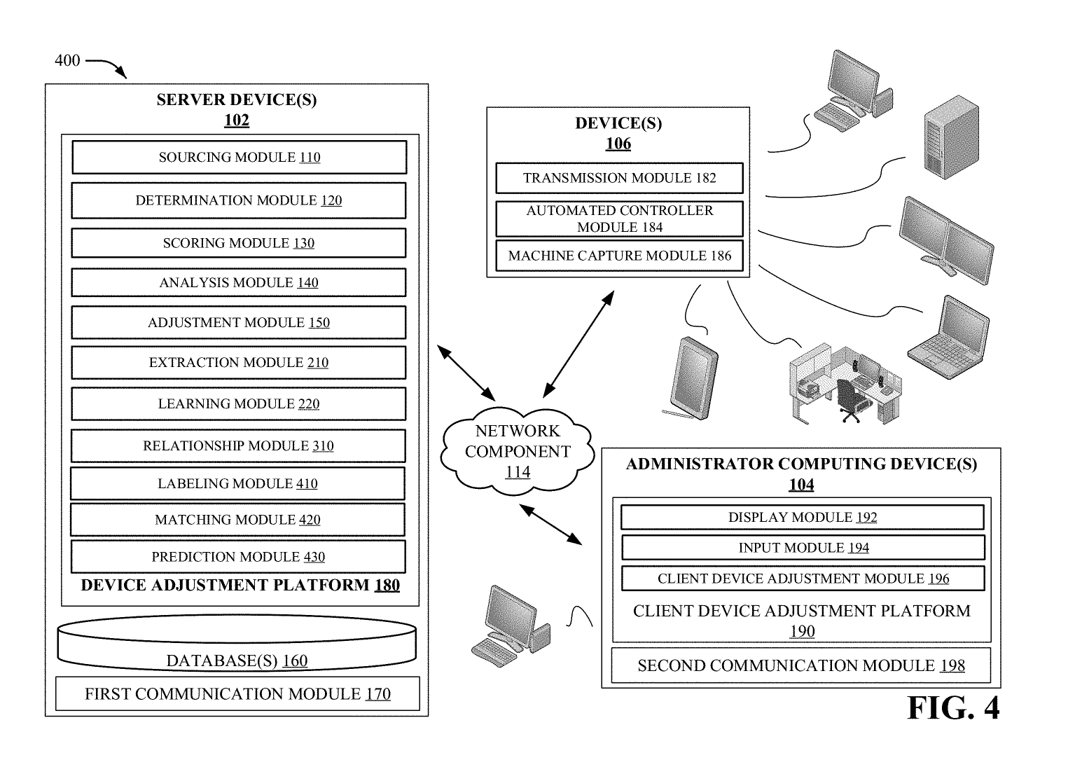

Turning now to FIG. 4, illustrated is a block diagram of an example, non-limiting environment 400, in which a device attribute or a configuration of a device component is automatically adjusted based on the predicting of the adjusted security vulnerability score in accordance with one or more embodiments described herein. Repetitive description of like elements employed in other embodiments described herein is omitted for sake of brevity.

In a non-limiting embodiment, server device(s) 102 can employ device adjustment platform 180 in connection with a labeling module 410 configured to label the device attribute data and the device component data. In an aspect, labeling module 410 can classify content or vulnerability data relating to device(s) 106 in accordance with visual feature extraction (e.g., images of devices) and supervised classification techniques. For instance, where machine vision technologies are utilized to capture images and video of device functioning and operations, such information (image data, video data) and its association with vulnerability data of such devices can be classified according to pixel images. Furthermore, in an aspect, a labeling module 410 can employ a supervised classification model to learn a function which assigns labels to vulnerability data (including image data and video data that corresponds to such vulnerability data). As such, the labeling of initial vulnerability data and image data can be referred to as a training phase.

In an aspect, labeling module 410 can classify labels according to perceptive attributes of the device data, vulnerability data, image data, and other sets of data. For instance, various labels can correspond to an orientation or location of a monitor displaying PHI based on viewpoint data, illumination changes (associated with the monitor images), occlusions in image data, geometrical transformations of such data, other such features of the data. In an aspect, learning module 410 can perform large-scale vulnerability data analysis based on a utility of sufficient computation power (e.g., dozens or hundreds of server devices and processors) to analyze thousands of data sets belonging to thousands of device(s) 106 and vulnerability scores and data simultaneously.

In another non-limiting embodiment, labeling module 410 can perform labeling operations in a local environment that is performed on device(s) 106 or low-powered devices that does not require sending and retrieving vulnerability data to a cloud architecture. Furthermore, labeling module 410 can perform labeling operations within a target confidence interval (e.g., higher confidence score) based on confirmation techniques that verify the labeling tasks. In another aspect, labeling module 410 can be utilized in a low memory environment that requires less storage space than other labeling mechanisms by utilizing concise vulnerability score descriptors to facilitate labeling and performance of low storage requirement aggregation representations of vulnerability data labeling. Furthermore, labeling module 410 can utilize small data classifiers to allow for local storage of prediction models that can be utilized detect an occurrence of sensitive content required for labeling as such sensitive content is generated.

In yet another aspect, adjustment platform 180 can employ matching module 420 configured to match labeled device attribute data and labeled device component data to groups of historical device security solutions. In an aspect, matching module 420 can match a labeled device attribute such as labeled data corresponding to orientations of device(s) 106 with a device type (e.g., a display monitor, a tablet display, a smartphone display, a position of device monitors relative to public viewing areas of a region). Furthermore, matching module 420 can match labeled device data to automated adjustment solutions learned (e.g., using learning module 410) from other device adjustments (e.g., performed by adjustment module 150) where such device(s) 106 had similar attributes to the subject device. In another embodiment, learning module 510 can adapt a parameter utilized by a machine learning model applied to a device(s) 106 that has a lower vulnerability score or has been determined to have a change in vulnerability score of a significant delta (from high score to low score) based on automated adjustments to improve a reliability of a predicted outcome (e.g., change in vulnerability score) of another device that may incorporate similar automated adjustments (e.g., using adjustment module 150).

In another non-limiting embodiment, adjustment platform 180 can employ prediction module 430 configured to predict an adjusted security vulnerability score based on implementation of at least a subgroup of historical device security solutions. In an aspect, prediction module 430 can predict adjustments to be performed (e.g., by adjustment module 150) that can include mechanical automated movement of device(s) 106 but also load balancing problem solutions. For instance, based on various computing resource (e.g., memory, storage, network bandwidth, etc.) needs to support various operations, prediction module 430 can predict the reallocation of computing resources among difference physical devices (e.g., servers) to address dynamic needs during execution of tasks (e.g., determination of vulnerability scores of thousands of device(s) 106 simultaneously, etc.).

In another aspect, prediction module 430 can predict potential vulnerability scores and corresponding vulnerabilities that could result from a suboptimal allocation of computing resources to various tasks (e.g., performing automated adjustments on some device(s) 106 and not others simultaneously). In an aspect, prediction module 430 performs predictive determinations and not reactive assessments such that prediction module 430 can predict a consequence of scenarios in which predefined vulnerability thresholds are exceeded for a critical mass of device(s) 106 during a given time. Furthermore, prediction module 430 can employ solutions in connection with adjustment module 150 to automatically adjust device(s) 106 upon an occurrence of such predicted scenarios. In another aspect, prediction module 430 can suggest to adjustment module 150 a particular automated adjustment (e.g., increase or decrease a specified computing resource) based on the exceeding of a predefined threshold (e.g., vulnerability score associated with insufficient resource allotment). Furthermore, adjustment module 150 can employ a rules-based or machine learning based module that can analyze computing resource utilization of environment 400 and various system operations. In another aspect, adjustment module 150 can be configured to automatically adjusts the device attribute or a configuration of the device component based on the predicting (e.g., using prediction module 430) of the adjusted security vulnerability score.

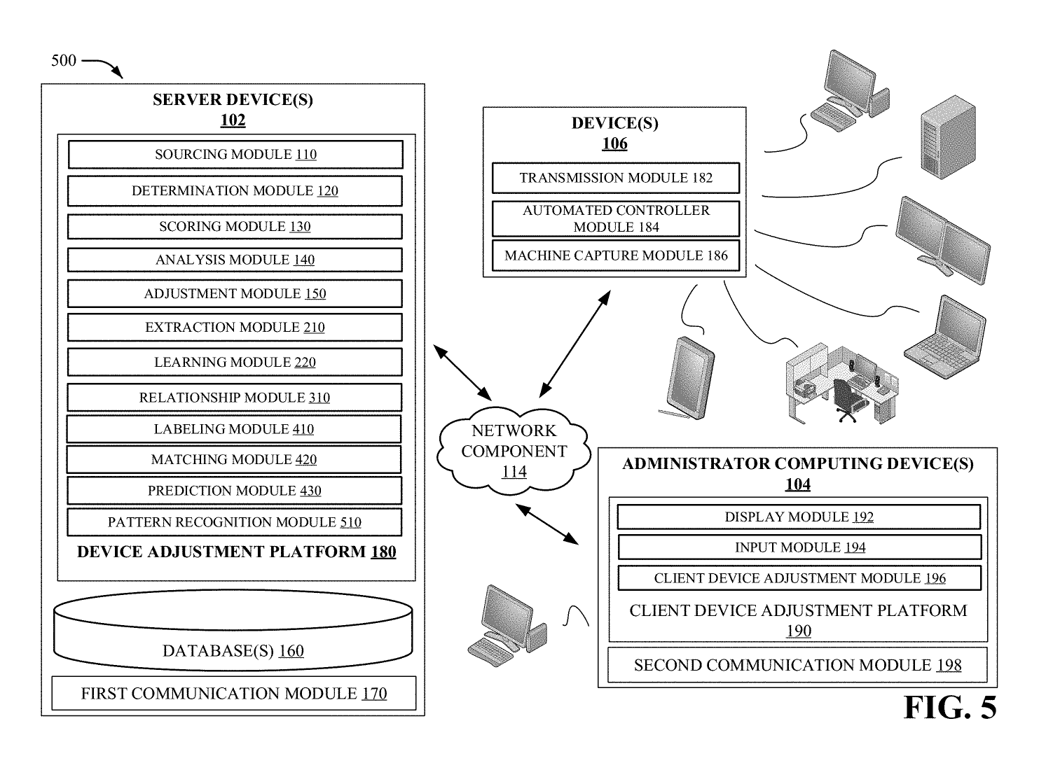

Turning now to FIG. 5, illustrated is a block diagram of an example, non-limiting environment 500, in which a device such as a display device can be automatically adjusted based on an occurrence of a predetermined vulnerability pattern in accordance with one or more embodiments described herein. Repetitive description of like elements employed in other embodiments described herein is omitted for sake of brevity.

In an aspect, device adjustment platform 180 can employ pattern recognition module 510 configured to determine vulnerability patterns of the device(s) 106 based on received location data representing a location of a group of devices, wherein the location comprises at least one of an orientation of a display of the device, a period of time that the display is unattended based on detection data from a detection sensor of the device, or a location of a display in a vulnerable location. In an aspect, pattern recognition module 510 can determine vulnerability patterns based on orientation of monitors (e.g., vulnerability of PHI viewability). For instance, a monitor or screen (e.g., device(s) 106) can employ photo-detector sensors to detect light sources based on detected photodetector data such that pattern recognition module 510 can determine symmetrical and asymmetrical patterns that indicate an orientation of a device(s) 106 based on the pattern (e.g., pattern of light reflection of objects such as device(s) 106, shadowing detection, perspective distortion data, optical aberration data, etc.).

In another non-limiting embodiment, pattern recognition module 510 can employ pattern recognition processing techniques to identify vulnerability data associated with device(s) 106. For instance, pattern recognition module 510 can transmit a request for a matching module 420 to identify an unknown item tor unknown data that may correspond to a vulnerability of device(s) 106. In an aspect, matching module 420 can identify the unknown item by matching the content to reference data based on relationships determined by relationship module 310 (e.g., relationship between unknown content, device(s) attributes, vulnerability characteristic of device(s) 106, and an automated adjustment to mitigate such vulnerability).

In an aspect, unknown data can correspond to unknown image or video data captured of device(s) 106 functioning, a search query, an unknown image of a pattern (e.g., for pattern recognition by pattern recognition module 510), or other such unknown data that can be matched against a database of relationship data. In an aspect, pattern recognition module 510 can employ algorithms to identify unknown items (e.g., vulnerability attributes of a device, automated adjustment solution for a vulnerability, etc.) such as a path pursuit algorithm, nearest neighbor algorithm, probabilistic point location in equal balls algorithm, point search algorithm, and other such algorithms to determine the maximum likelihood that an unknown item corresponds to a vulnerability attribute of a device(s) 106. Accordingly, adjusting module 150 can be configured to adjust the display (e.g., automatically adjust an orientation of a display or power setting of such display) based on the vulnerability pattern, wherein the adjusting is at least one of a mechanical movement of the display to re-orient in a less vulnerable direction than the orientation, automatically power down or employ screen saver mode of the display during a predefined time period; or deploy video recording capabilities during a predefined time period.

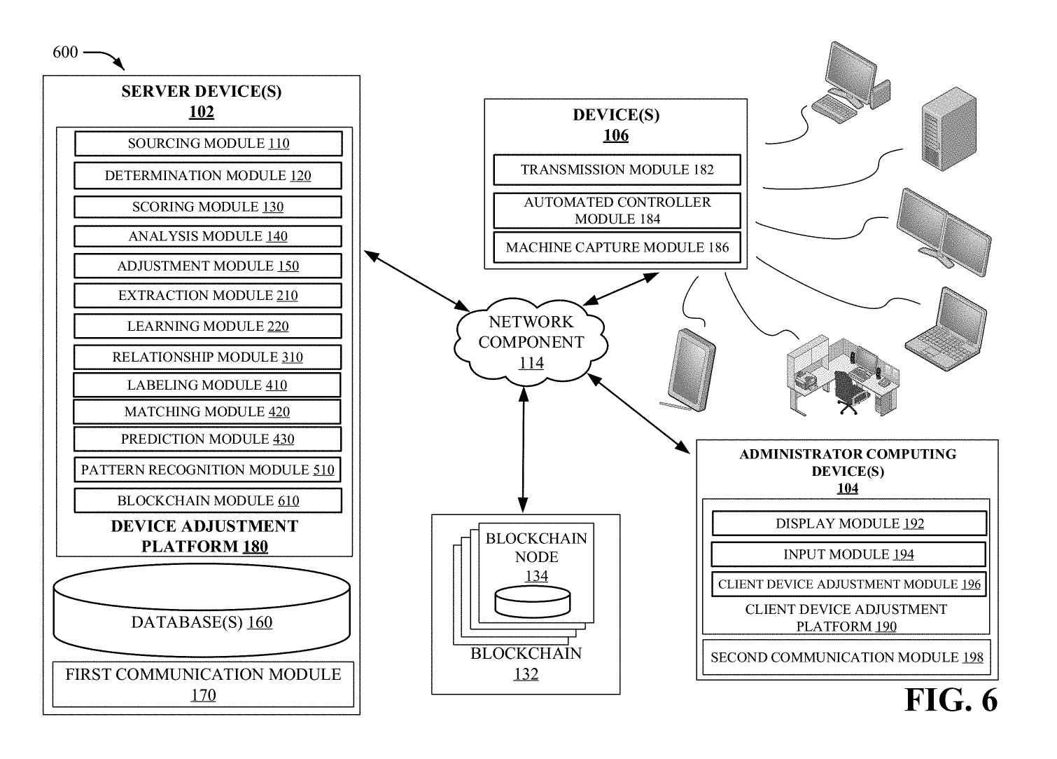

Turning now to FIG. 6, illustrated is a block diagram of an example, non-limiting environment 600, in which changes in security vulnerability scores and adjustment data corresponding to automatic adjustments to device attributes or device components are stored at one or more nodes of a chain of nodes within a blockchain data store in accordance with one or more embodiments described herein. Repetitive description of like elements employed in other embodiments described herein is omitted for sake of brevity.

In an aspect, device adjustment platform 180 can employ blockchain module 610 configured to store changes in security vulnerability scores and adjustment data corresponding to the automatically adjusting the device attributes or the device components at one or more blockchain nodes 134 of a chain of nodes within a blockchain data store 132. In an aspect, blockchain module 310 can transmit data from server device(s) 102 either as duplicate data or original data to a blockchain system employing blockchain 132. In another non-limiting aspect, vulnerability data (e.g., device(s) 106 data, automated adjustment data, vulnerability score data, etc.) can be transmitted to blockchain 132 as original data (non-duplicate data), such that the blockchain system serves as a primary data store for one or more sets of data.

In an embodiment, only the additional data in a transaction (not including the previously transmitted duplicate data) can be transmitted for incorporation onto the blockchain 132. As such, the blockchain can be configured to store data corresponding to the data of device adjustment platform 180. In an aspect, blockchain 132 is a data structure that stores a list of transactions. In an aspect, blockchain 132 can be a distributed electronic ledger that records transactions between various stakeholders (e.g., server device(s) 102 and device(s) 106, queries from administrator computing device(s) 104, vulnerability scores of respective device(s) 106, automated adjustment data transactions that occur, etc.) and other operations executed by one or more processor within environment 600. In one or more non-limiting embodiments, blockchain 132 can be a decentralized public (or private) transaction ledger that can be deployed over one or more node 134 (e.g., server) and configured to perform transaction-based state transitions and smart contract functionality.

In a non-limiting implementation, administrator computing device(s) 104 can interact with a server device(s) 102 configured to control one or more node (e.g., blockchain node 134 and other such nodes) of blockchain 132. In an aspect, server device (s) 102 can be configured to facilitate access to one or more node of blockchain 132. For instance, server device(s) 102 can control access to blockchain node 134 that represents an Ethereum blockchain or other distributed ledger node featuring transaction-based state transitions and/or smart contract functionality. In an aspect, vulnerability data of device(s) 106 can stored on the blockchain 132 to make use of encryption mechanisms employed by blockchain 132 such that only authorized data on an immutable blockchain is accessed by users with authorization credentials. Furthermore, the data stored on each block is immutable (e.g., cannot be modified or altered) such that a tamper proof transaction record of device(s) 106 vulnerabilities and access to data such as PHI can be provided. As such, chain of identity and chain of custody data can be stored and easily queried on blockchain 132.

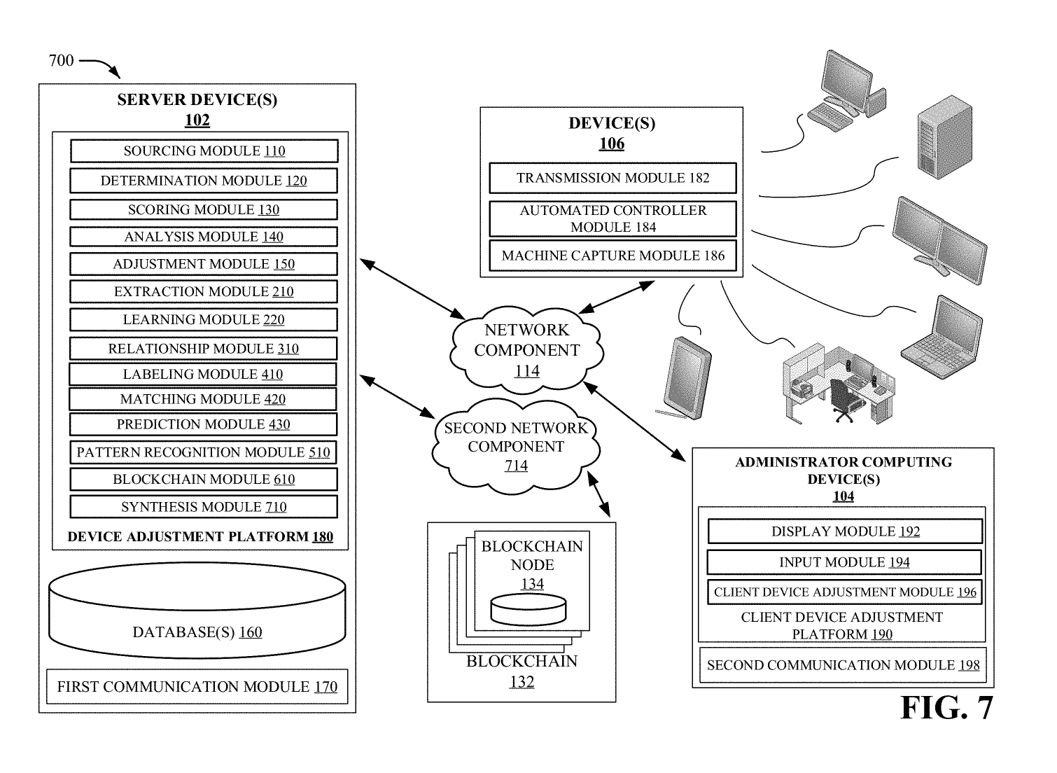

Turning now to FIG. 7, illustrated a block diagram of an example, non-limiting environment 700, in which images are stitched based on a stitching algorithm, captured by the camera recording technology corresponding to at least two of the devices to generate a field of view that provides context to a location to the at least two of the one or more devices in accordance with one or more embodiments described herein. Repetitive description of like elements employed in other embodiments described herein is omitted for sake of brevity.

In an aspect, device adjustment platform 180 can employ synthesis module 710 configured to stitches images, based on a stitching algorithm, captured by the camera recording technology corresponding to at least two of the devices to generate a field of view that provides context to a location to the at least two of the one or more devices. In an aspect, synthesis module 710 can utilize images from camera devices capturing device(s) 106 activities and stitch together several images to create location maps of various device(s) 106. Furthermore, such location maps (e.g., created by synthesis module 710 stitching) can identify areas of vulnerability associated with device(s) 106 location and orientation. For instance, synthesis module 710 can stitch together images from several camera devices that indicate regions of public viewability of PHI displayed on device(s) 106 screens. Accordingly, adjustment module 150 can automatically adjust a set of device(s) 106 screens based on a determination (e.g., using scoring module 130) of a vulnerability score based in part on the stitched images and area maps (of vulnerable locations). As such, adjustment module 150 can employ an automated adjustment of orientation of screens of device(s) 106 based on the vulnerability areas located.

In an aspect, environment 400 can employ a second network component 714 that facilitates communication between blockchain 132 and a central service provider device such as server device(s) 102 and a network component 114 that facilitates communication between server device(s) 102 and external service provider device(s) such as administrator computing device(s) 104 and device(s) 106. In an aspect, network component 114 and second network component 714 can comprise at least the same functionality as network component 114. As such, in some non-limiting embodiments, device adjustment platform 180 can serve as a central service provider that must be utilized to access the blockchain data store 132.

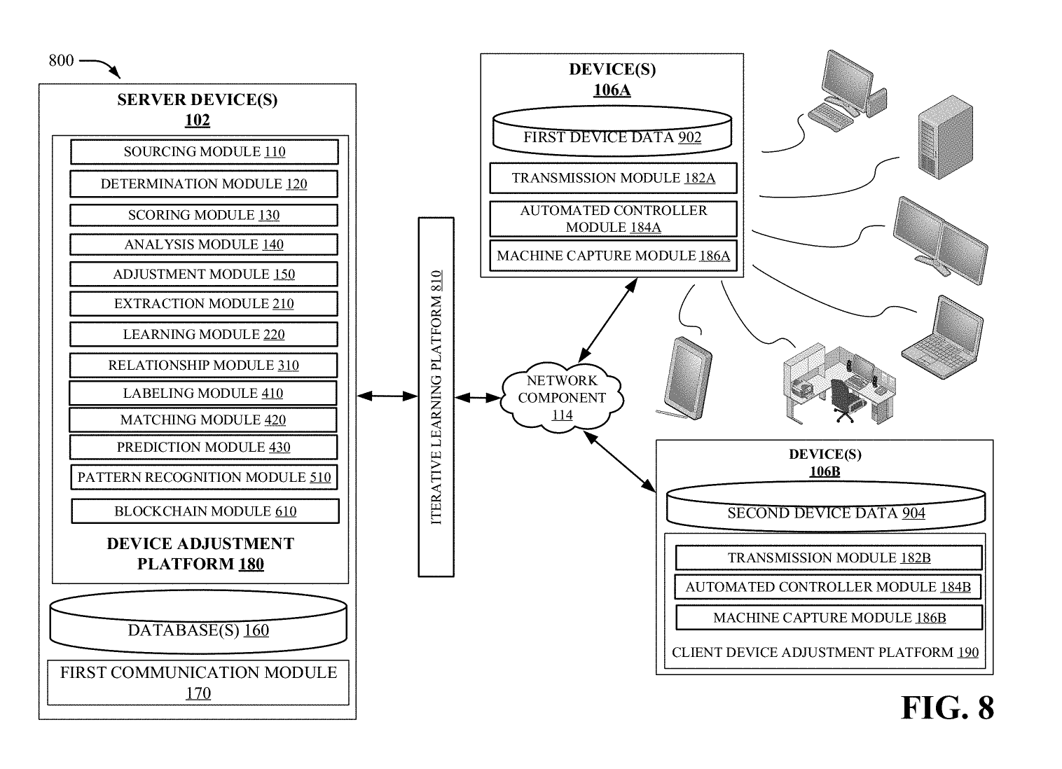

Turning now to FIG. 8, illustrated is a block diagram of an example, non-limiting environment 800, in which hyperparameters and learnings can be extracted from a machine learning algorithm applied to vulnerability data corresponding to a first device and integrated into another machine learning algorithm for application on vulnerability data corresponding to a different device in accordance with one or more embodiments described herein. Repetitive description of like elements employed in other embodiments described herein is omitted for sake of brevity.

In an aspect server device(s) 102 employing device adjustment platform 180 can operate in connection with iterative learning platform 810 to provide data abstraction capabilities that allow the application of learned information from device(s) 106A to be applied to device(s) 106B without exposing the underlying data stored at first device datastore 902. As an example, consider a scenario in which device adjustment platform 180 automatically adjusted several screen orientations of device(s) 106A to reduce vulnerability scores based on a determination that vulnerability scores were above a predefined threshold level. As such, iterative learning platform 810 can extract (e.g., in connection with extraction module 210) respective machine learning information, model updates, and model parameters (e.g., hyper-parameters) and anecdotal data corresponding to device(s) 106 and apply such extracted learnings to machine learning models applied to device 106(b) data. As such, adjustment module 150 can employ automated adjustments (e.g., using automated controller module 184B) similar to those automated adjustments implemented by automated controller module 184A on device(s) 106A given that device(s) 106A and device(s) 106B have similar attributes, characteristics, and vulnerability circumstances.

In another aspect, machine capture module 196A and machine capture module 186B can capture machine vision data for transmission to iterative learning platform 810 via transmission module 182A and transmission module 182B respectively. In yet another aspect, iterative learning platform 810 can capture learnings for application to several devices via feedback loop. For instance, iterative learning platform 810 can continue to enhance its learnings as more device(s) 106 are evaluated and reapply updated learnings to respective device(s) (e.g., device(s) 106A and device(s) 106B for instance) on a recurring basis. As such, the learnings, updated automated adjustment information, updated device(s) 106 diagnostic information, updated insights, various hyper-parameters and other information used by machine learning algorithms to identify vulnerability information, vulnerability scores, and automated adjustments to device(s) 106 to be performed can be shared with other systems and devices using iterative learning platform 810.

As an example, consider learnings that correspond to various types of anecdotal data, machine-learning algorithm observations, reinforcement learning information, hyper-parameters and other information generated by device(s) 106A. These learnings can be forwarded (e.g., using iterative learning platform 810) to server device(s) 102 (for evaluation, labeling, matching, relationship assessment, blockchain storage, pattern recognition evaluation, and automated adjustment determination by various modules) and again forwarded (e.g., via iterative learning platform 810 to other device(s) such as device(s) 106B. Accordingly, the forwarded learnings can integrate the learning information into the information provided by device adjustment platform 180 to perform an automated adjustment to device(s) 106 that are customized to device(s) 106B.

Furthermore, in an aspect, iterative learning platform 810 can employ a logical format language that allows such platform to communicate with several varied underlying technologies and language formats (e.g., disparate technologies) used by distinct device(s) 106. In an aspect, iterative learning platform 810 can change the behavior or vulnerability score of device(s) 106B without compromising the security of device(s) 106A. In an aspect, such vulnerability score lessening can include implementation of automated adjustments that improve efficiency of analysis operations. As one non-limiting example, a set of hyper-parameters can be adjusted or tuned to generate optimal hyper-parameter values to improve efficiency, such as by using grid search techniques, random search technique, Bayesian optimization technique, as part of the tuning algorithms. In various implementations, the device adjustment platform 180 in connection with iterative learning platform 810 determines which of the hyper-parameters are relevant for tuning based on a predictive learning model or target outcome (e.g., lowering a device(s) 106 vulnerability score).

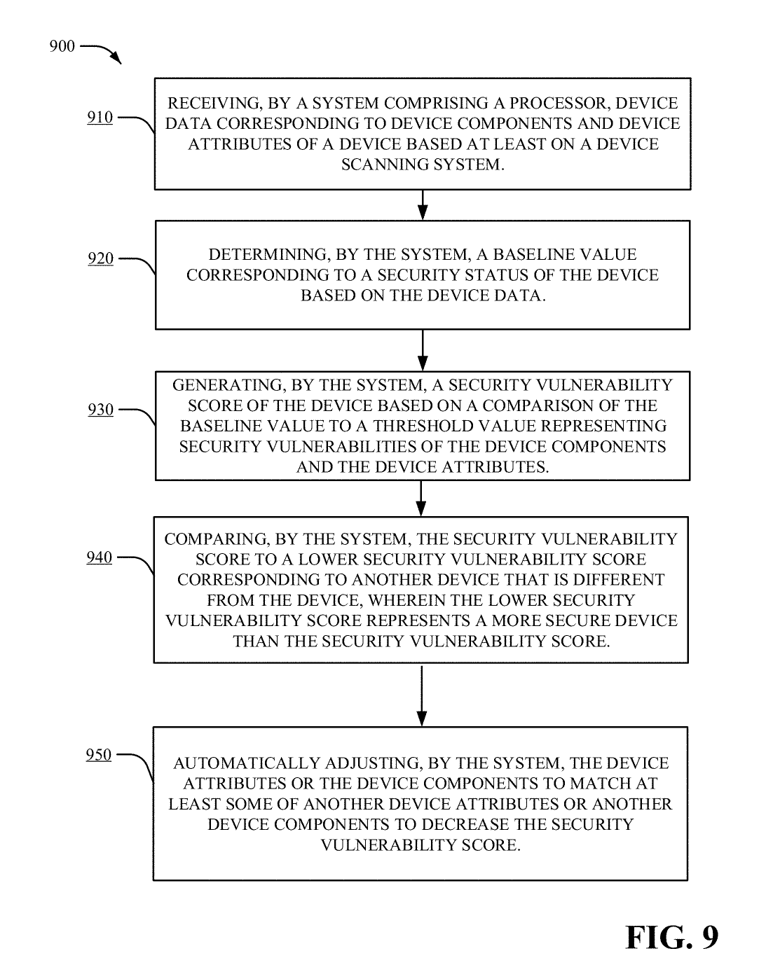

Turning now to FIG. 9, illustrated is a flow diagram of an example, non-limiting computer-implemented method 900 that can facilitate an automated adjustment of device attributes, components, or configurations based on vulnerability scores in accordance with one or more non-limiting embodiments described herein. In an aspect, one or more of the components described in computer-implemented method 900 can be electrically and/or communicatively coupled to one or more devices. Repetitive description of like elements employed in other embodiments described herein is omitted for sake of brevity.

In some implementations, at reference numeral 910, a system operatively coupled to a processor can receive (e.g., using sourcing module 110) device data corresponding to device components and device attributes of a device based at least on a device scanning system. At 920, the system can determine (e.g., using determination module 120) a baseline value corresponding to a security status of the device based on the device data. At 930, the system can generate (e.g., using scoring module 130) a security vulnerability score of the device based on a comparison of the baseline value to a threshold value representing security vulnerabilities of the device components and the device attributes.

At 940, the system can compare (e.g., using analysis module 140) the security vulnerability the security vulnerability score corresponding to another device that is different from the device, wherein the lower security vulnerability score represents a more secure device than the security vulnerability score. At 950, the system can automatically adjust (e.g., using adjustment module 150) the device attributes or the device components to match at least some of another device attributes or another device component to decrease the security vulnerability score.

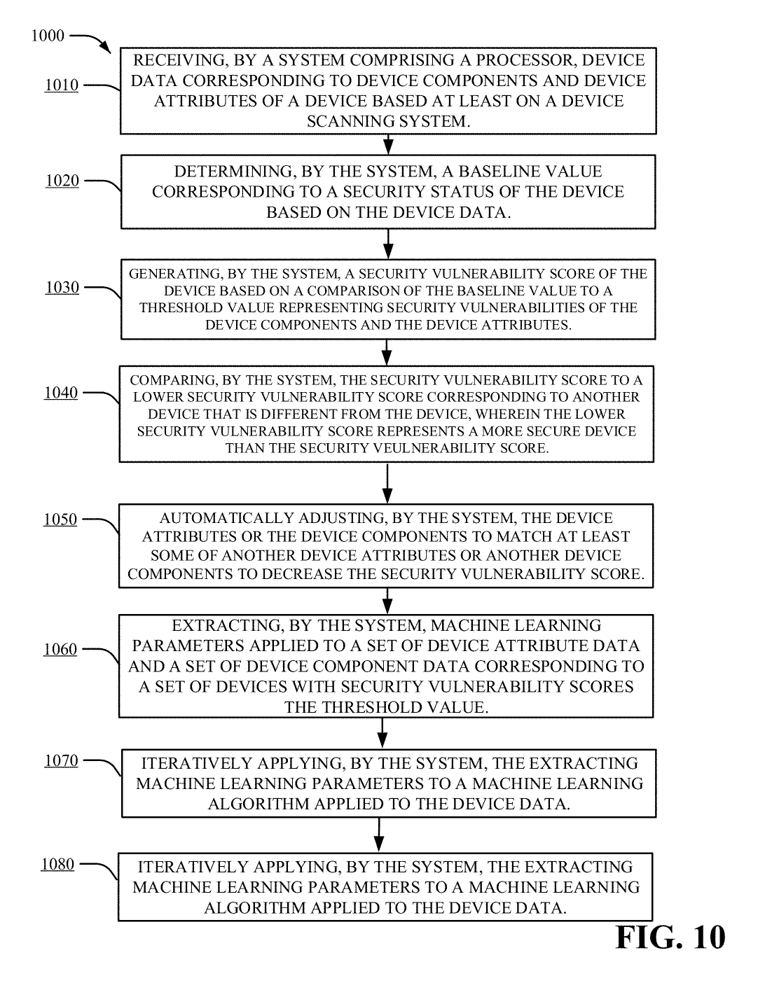

FIG. 10 illustrates a flow diagram of an example, non-limiting computer-implemented method 1000 that can facilitate an automated adjustment of device attributes, components, or configurations based on vulnerability scores in accordance with one or more non-limiting embodiments described herein. In an aspect, one or more of the components described in computer-implemented method 1000 can be electrically and/or communicatively coupled to one or more devices. Repetitive description of like elements employed in other embodiments described herein is omitted for sake of brevity.

In some implementations, at reference numeral 1010, a system operatively coupled to a processor can receive (e.g., using sourcing module 110) device data corresponding to device components and device attributes of a device based at least on a device scanning system. At 1020, the system can determine (e.g., using determination module 120) a baseline value corresponding to a security status of the device based on the device data. At 1030, the system can generate (e.g., using generation module 130) a security vulnerability score of the device based on a comparison of the baseline value to a threshold value representing security vulnerabilities of the device components and the device attributes.

At 1040, the system can compare (e.g., using analysis module 140) the security vulnerability the security vulnerability score corresponding to another device that is different from the device, wherein the lower security vulnerability score represents a more secure device than the security vulnerability score. At 1050, the system can automatically adjust (e.g., using adjustment module 150) the device attributes or the device components to match at least some of another device attributes or another device component to decrease the security vulnerability score. At 1060, the system can comprise extracting (e.g., using extraction module 210) by the system, machine learning parameters applied to a set of device attribute data and a set of device component data corresponding to asset of devices with security vulnerability scores above the threshold value. At 1070, the system can iteratively apply (e.g., using learning module 220) the extracted machine learning parameters to a machine learning algorithm applied to the device data. At 1080, the system can generate (e.g., using generation module) vulnerability insights from the machine learning algorithm based on the extracting machine learning parameters in connection with the machine learning algorithm.

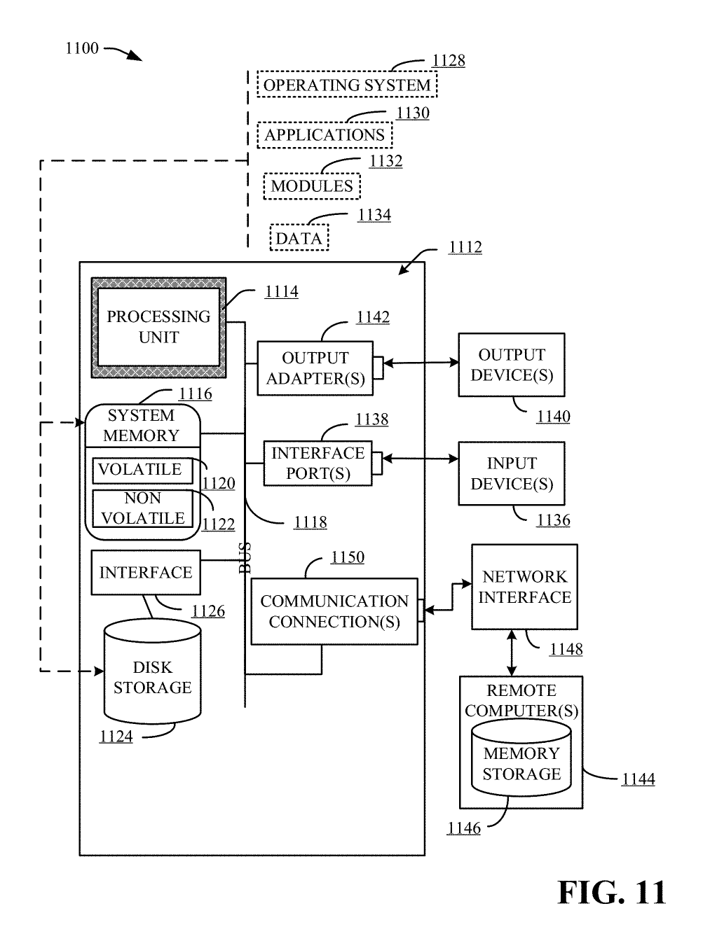

FIG. 11 illustrates a block diagram of an example, non-limiting operating environment 1100 in which one or more embodiments described herein can be facilitated. In order to provide a context for the various aspects of the disclosed subject matter, FIG. 11 as well as the following discussion is intended to provide a general description of a suitable environment in which the various aspects of the disclosed subject matter can be implemented. FIG. 11 illustrates a block diagram of an example, non-limiting operating environment in which one or more embodiments described herein can be facilitated. With reference to FIG. 11, a suitable operating environment 1100 for implementing various aspects of this disclosure can also include a computer 1112. The computer 1112 can also include a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114. The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1116 can also include volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1120 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1112 can also include removable/non-removable, volatile/non-volatile computer storage media. FIG. 11 illustrates, for example, a disk storage 1124. Disk storage 1124 can also include, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1124 to the system bus 1118, a removable or non-removable interface is typically used, such as interface 1126. FIG. 11 also depicts software that acts as an intermediary between users and the basic computer resources described in the suitable operating environment 1100. Such software can also include, for example, an operating system 1128. Operating system 1128, which can be stored on disk storage 1124, acts to control and allocate resources of the computer 1112.

System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems. A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapter 1142 is provided to illustrate that there are some output device 1140 like monitors, speakers, and printers, among other such output device 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a computer, a server, a router, a network PC, a workstation, a microprocessor based appliance, a peer device or other common network node and the like, and typically can also include many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1150 refers to the hardware/software employed to connect the network interface 1148 to the system bus 1118. While communication connection 1150 is shown for illustrative clarity inside computer 1112, it can also be external to computer 1112. The hardware/software for connection to the network interface 1148 can also include, for exemplary purposes only, internal and external technologies such as, modems including regular telephone grade modems, cable modems and DSL modems, ISDN adapters, and Ethernet cards.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a processing system that implements a device adjustment system comprising:
a sourcing module configured to receive device data corresponding to device components and device attributes of a device based at least on a device scanning system;
a determination module configured to determine a baseline value corresponding to a security status of the device based on device data;
a scoring module configured to generate a security vulnerability score of the device based on a comparison of the baseline value to a threshold value representing security vulnerabilities of the device components and the device attributes;
an analysis module configured to compare the security vulnerability score to a lower security vulnerability score corresponding to another device that is different from the device, wherein the lower security vulnerability score represents a more secure device than the security vulnerability score; and
an adjustment module configured to automatically adjust the device attributes or the device components to match at least some another device attributes or another device components to decrease the security vulnerability score.

2. The system of claim 1, further comprising:
an extraction module configured to extract machine learning parameters applied to a set of device attribute data and a set of device component data corresponding to a set of devices with security vulnerability scores above the threshold value;
a learning module configured to iteratively applying the extract machine learning parameters to a machine learning algorithm applied to the device data; and
a generation module configured to generate vulnerability insights from the machine learning algorithm based on the extracting machine learning parameters in connection with the machine learning algorithm.

3. The system of claim 2, further comprising:
a relationship module configured to generating relationship models between the vulnerability insights and adjustments to the device attributes or the device components; and
the adjusting module automatically adjusts the device attributes, or the device components based on the generating relationship models.

4. The system of claim 2, wherein the machine learning algorithm comprises:
a labeling module configured to label the device attribute data and the device component data;
a matching module configured to match labeled device attribute data and labeled device component data to groups of historical device security solutions;
a prediction module configured to predict an adjusted security vulnerability score based on implementation of at least a subgroup of historical device security solutions;
the adjustment module configured to automatically adjusts the device attribute or a configuration of the device component based on the predicting of the adjusted security vulnerability score.

5. The system of claim 1, further comprising:
the extraction module configured to extract learning parameters from a first machine learning model applied to a group of devices; and
the learning module configured to applying a second machine learning model employing the extracted learning parameters to a second set of devices comprising at least the device, and wherein the second set of devices are different than the first set of physical devices.

6. The system of claim 1, further comprising:
pattern recognition module configured to determine vulnerability patterns of the device based on received location data representing a location of a group of devices, wherein the location comprises at least one of an orientation of a display of the device, a period of time that the display is unattended based on detection data from a detection sensor of the device, or a location of a display in a vulnerable location; and
adjusting module configured to adjust the display based on the vulnerability pattern, wherein the adjusting is at least one of a mechanical movement of the display to re-orient in a less vulnerable direction than the orientation, automatically power down or employ screen saver mode of the display during a predefined time period; or deploy video recording capabilities during a predefined time period.

7. The system of claim 4, further comprising the determination module configured to determine the extracting learning parameters based at least in part on a comparison of performance data between the device and the set of devices.

8. The system of claim 1, further comprising a blockchain module storing changes in security vulnerability scores and adjustment data corresponding to the automatically adjusting the device attributes or the device components at one or more nodes of a chain of nodes within a blockchain data store.

9. The system of claim 1, wherein the device scanning technology is based at least in part on a machine vision recognition technology, camera recording technology, gesture recognition technology, or object detection sensor, wherein the automatically adjusting the device attribute or a configuration of the device component comprises controlling physical device-level operations and elements comprising at least one of a device controller and actuator element to physically re-orient or move the device based on receipt of at least one control signal, or movement of a sensor to detect object presence or absence, wherein the sourcing module is configured to receive machine data comprising sensor data, control signal data, actuator data from the device components, and wherein the device data further comprises controlling module configured to automatically adjust at least one of a sensor level operation, a screen orientation adjustment, or a screen powering operation.

10. The system of claim 9, further comprising a synthesis module that stitches images, based on a stitching algorithm, captured by the camera recording technology corresponding to at least two of the devices to generate a field of view that provides context to a location to the at least two of the one or more devices.

11. A system comprising:
one or more storage devices that store computer executable components; and
one or more processors that execute the computer executable components stored in the one or more storage devices, wherein the computer executable components comprise:
receiving device data corresponding to device components and device attributes of a device based at least on a device scanning system;
determining a baseline value corresponding to a security status of the device based on device data;
generating a security vulnerability score of the device based on a comparison of the baseline value to a threshold value representing security vulnerabilities of the device components and the device attributes;
comparing the security vulnerability score to a lower security vulnerability score corresponding to another device that is different from the device, wherein the lower security vulnerability score represents a more secure device than the security vulnerability score; and
automatically adjusting the device attributes or the device components to match at least some another device attributes or another device components to decrease the security vulnerability score.

12. The system of claim 11, further comprising:
extracting machine learning parameters applied to a set of device attribute data and a set of device component data corresponding to a set of devices with security vulnerability scores above the threshold value;
iteratively applying the extracting machine learning parameters to a machine learning algorithm applied to the device data; and
generating vulnerability insights from the machine learning algorithm based on the extracting machine learning parameters in connection with the machine learning algorithm.

13. The system of claim 12, further comprising:
generating relationship models between the vulnerability insights and adjustments to the device attributes or the device components; and
automatically adjusting the device attributes or the device components based on the generating relationship models.

14. The system of claim 12, wherein the machine learning algorithm comprises:
labeling the device attribute data and the device component data;
matching labeled device attribute data and labeled device component data to groups of historical device security solutions;
predicting an adjusted security vulnerability score based on implementation of at least a subgroup of historical device security solutions;
automatically adjusting the device attribute or a configuration of the device component based on the predicting of the adjusted security vulnerability score.

15. The system of claim 11, further comprising:
extracting learning parameters from a first machine learning model applied to a group of devices; and
applying a second machine learning model employing the extracted learning parameters to a second set of devices comprising at least the device, and wherein the second set of devices are different than the first set of physical devices.

16. The system of claim 11, further comprising:
determining vulnerability patterns of the device based on received location data representing a location of a group of devices, wherein the location comprises at least one of an orientation of a display of the device, a period of time that the display is unattended based on detection data from a detection sensor of the device, or a location of a display in a vulnerable location; and
adjusting the display based on the vulnerability pattern, wherein the adjusting is at least one of a mechanical movement of the display to re-orient in a less vulnerable direction than the orientation, automatically power down or employ screen saver mode of the display during a predefined time period; or deploy video recording capabilities during a predefined time period.

17. The system of claim 14, determining the extracting learning parameters based at least in part on a comparison of performance data between the device and the set of devices.

18. A method comprising:
transmitting, by a device, device data corresponding to device components and device attributes of the device based on a request of a device scanning system; and
automatically adjusting, by the device, at least one of a device orientation, a device screen display setting, a device physical position or location, or a device camera span of view based on control data or configuration data received from an automated control system.

19. The method of claim 18, further comprising automatically adjusting, by the device, the device attributes or a configuration of the device components based on a security vulnerability score being less than a threshold security vulnerability score.

20. The method of claim 18, further comprising:
automatically capturing, by the device, select video data, select image data, or select audio data that generate an environmental status of the device; and
triggering an automated transmission, by the device, of the environmental status to the device scanning system based on the security vulnerability score being less than a threshold security vulnerability score.
